(19) United States
(12) Patent Application Publication
(10) Pub. No.: US 2026/0120328 A1
(43) Pub. Date: Apr. 30, 2026

(54) FIXED-POINT INTEGER IMPLEMENTATION OF NORMAL VECTOR ENCODING IN V-DMC BASE MESH CODER

(71) Applicant: QUALCOMM Incorporated, San Diego, CA (US)

(72) Inventors: Anique Akhtar, San Diego, CA (US); Geert Van der Auwera, San Diego, CA (US); Adarsh Krishnan Ramasubramonian, Irvine, CA (US); Reetu Hooda, San Diego, CA (US); Marta Karczewicz, San Diego, CA (US)

(21) Appl. No.: 19/366,792

(22) Filed: Oct. 23, 2025

Related U.S. Application Data
(60) Provisional application No. 63/712,120, filed on Oct. 25, 2024.

(51) Int. Cl. G06T 9/00; G06T 3/40; H04N 19/70

(52) U.S. Cl. CPC G06T 9/001; G06T 3/40; H04N 19/70

(57) ABSTRACT

A device for processing mesh data is configured to select one of multi-parallelogram prediction or cross product prediction as a selected prediction process for a mesh of the mesh data; in response to determining for a first vertex of the mesh that a first set of already decoded normal vectors are available, determine a predicted normal vector for the first vertex using the selected prediction process; normalize and scale the predicted normal vector for the first vertex to generate a normalized and scaled normal vector; and output a decoded version of the mesh based on the normalized and scaled normal vector.

This application claims the benefit of U.S. Provisional Patent Application No. 63/712,120, filed 25 Oct. 2024, the entire contents of which is incorporated herein by reference.

### TECHNICAL FIELD

This disclosure relates to video-based coding of dynamic meshes.

### BACKGROUND

Meshes may be used to represent physical content of a 3-dimensional space. Meshes have utility in a wide variety of situations. For example, meshes may be used in the context of representing the physical content of an environment for purposes of positioning virtual objects in an extended reality, e.g., augmented reality (AR), virtual reality (VR), or mixed reality (MR), application. Mesh compression is a process for encoding and decoding meshes. Encoding meshes may reduce the amount of data required for storage and transmission of the meshes.

### SUMMARY

This disclosure proposes a fixed-point integer implementation of normal vector encoding for video-based dynamic mesh coding (V-DMC). By normalizing and scaling the predicted normal for a first vertex to generate a normalized and scaled normal, the techniques of this disclosure may be used to implement a fixed-point integer implementation of normal vector encoding that results in improved coding performance.

According to an example of the present disclosure, a device for processing mesh data includes a memory; and processing circuitry coupled to the memory and configured to: select one of multi-parallelogram prediction or cross product prediction as a selected prediction process for a mesh of the mesh data; in response to determining for a first vertex of the mesh that a first set of already decoded normal vectors are available, determine a predicted normal vector for the first vertex using the selected prediction process; normalize and scale the predicted normal vector for the first vertex to generate a normalized and scaled normal vector; and output a decoded version of the mesh based on the normalized and scaled normal vector.

According to another example of the present disclosure, a method for processing mesh data includes selecting one of multi-parallelogram prediction or cross product prediction as a selected prediction process for a mesh of mesh data; in response to determining for a first vertex of the mesh that a first set of already decoded normal vectors are available, determining a predicted normal vector for the first vertex using the selected prediction process; normalizing and scaling the predicted normal vector for the first vertex to generate a normalized and scaled normal vector; and outputting a decoded version of the mesh based on the normalized and scaled normal vector.

According to another example of the present disclosure, a computer-readable storage medium stores instructions that when executed by one or more processors cause the one or more processors to: select one of multi-parallelogram prediction or cross product prediction as a selected prediction process for a mesh of mesh data; in response to determining for a first vertex of the mesh that a first set of already decoded normal vectors are available, determine a predicted normal vector for the first vertex using the selected prediction process; normalize and scale the predicted normal vector for the first vertex to generate a normalized and scaled normal vector; and output a decoded version of the mesh based on the normalized and scaled normal vector.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example encoding and decoding system that may perform the techniques of this disclosure.

FIG. 2 shows an example implementation of a video-based dynamic mesh coding (V-DMC) encoder.

FIG. 3 shows an example implementation of a V-DMC decoder.

FIG. 4 shows an example implementation of an intra-mode encoder for V-DMC.

FIG. 5 shows an example implementation of an intra-mode decoder for V-DMC.

FIG. 6 shows an example implementation of a V-DMC decoder.

FIG. 7 shows an example implementation of a coding process for coding base mesh connectivity.

FIG. 8 shows an example implementation of a base mesh encoder.

FIG. 9 shows an example implementation of a base mesh decoder.

FIG. 10A shows an example implementation of a base mesh encoder.

FIG. 10B shows an example implementation of a base mesh decoder.

FIG. 11A shows an example of multi-parallelogram prediction.

FIG. 11B shows an example of min stretch prediction.

FIGS. 12A-12D and FIG. 13 show how a 3D unit vector can be converted to a 2D octahedral representation.

FIG. 14A shows an implementation of normal encoding using octahedral representation.

FIG. 14B shows an implementation of normal decoding using octahedral representation.

FIG. 15 shows a flowchart of a normal decoding process.

FIG. 16 is a flowchart illustrating an example process for encoding a mesh.

FIG. 17 is a flowchart illustrating an example process for decoding a compressed bitstream of mesh data.

FIG. 18 is a flowchart illustrating an example process for decoding a compressed bitstream of mesh data.

### DETAILED DESCRIPTION

A mesh generally refers to a collection of vertices in a three-dimensional (3D) space that collectively represent one or multiple objects in the 3D space. The vertices are connected by edges, and the edges form polygons, which form faces of the mesh. Each vertex may also have one or more associated attributes, such as a texture or a color. In most scenarios, having more vertices produces higher quality, e.g., more detailed and more realistic, meshes. Having more vertices, however, also requires more data to represent the mesh.

To reduce the amount of data needed to represent the mesh, the mesh may be encoded using lossy or lossless encoding. In lossless encoding, the decoded version of the encoded mesh exactly matches the original mesh. In lossy encoding, by contrast, the process of encoding and decoding the mesh causes loss, such as distortion, in the decoded version of the encoded mesh.

In one example of a lossy encoding technique for meshes, a mesh encoder decimates an original mesh to determine a base mesh. To decimate the original mesh, the mesh encoder subsamples or otherwise reduces the number of vertices in the original mesh, such that the base mesh is a rough approximation, with fewer vertices, of the original mesh. The mesh encoder then subdivides the decimated mesh. That is the mesh encoder estimates the locations of additional vertices in between the vertices of the base mesh. The mesh encoder then deforms the subdivided mesh by moving the vertices in a manner that makes the deformed mesh more closely match the original mesh.

After determining a desired base mesh and deformation of the subdivided mesh, the mesh encoder generates a bitstream that includes data for constructing the base mesh and data for performing the deformation. The data defining the deformation may be signaled as a series of displacement vectors that indicate the movement, or displacement, of the additional vertices determined by the subdividing process. To decode a mesh from the bitstream, a mesh decoder reconstructs the base mesh based on the signaled information, applies the same subdivision process as the mesh encoder, and then displaces the additional vertices based on the signaled displacement vectors.

This disclosure proposes fixed-point integer implementation of normal vector encoding in the base mesh/static-mesh encoder of V-DMC Test Model v9 (hereinafter TMM v9), ISO/IEC JTC 1/SC 29/WG 7, MDS24185_WG07_N00951, July 2024, which is also known as MPEG Edge Breaker (MEB). Previously, U.S. Provisional Patent Application 63/575,039, filed 5 Apr. 2024, U.S. Provisional Patent Application 63/614,139, filed 22 Dec. 2023 (hereinafter “the '139 application”), proposed the integration of normal vector encoding in V-DMC Test Model v6.0 (TMM v6.0) that was later ported to TMM v7.0. U.S. Provisional Patent Application 63/635,219, filed 17 Apr. 2024 (hereinafter “the '219 application”), proposes improvements to the encoding of normals by introducing a 2D octahedral representation for normals that was integrated into TMM v8.0. However, these previous implementations involved floating-point calculations, which could lead to precision errors along with performance and implementation issues. This disclosure proposes a fixed-point integer implementation of normal vector encoding. By normalizing and scaling the predicted normal for the first vertex to generate a normalized and scaled normal, the techniques of this disclosure may be used to implement a fixed-point integer implementation of normal vector encoding that results in improved coding performance.

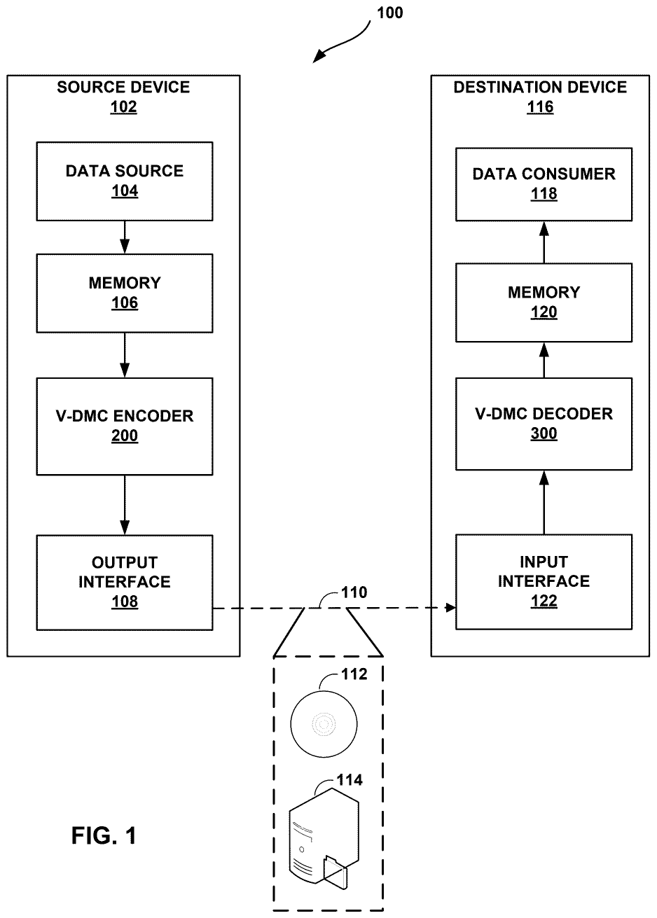

FIG. 1 is a block diagram illustrating an example encoding and decoding system 100 that may perform the techniques of this disclosure. The techniques of this disclosure are generally directed to coding (encoding and/or decoding) meshes. The coding may be effective in compressing and/or decompressing data of the meshes.

As shown in FIG. 1, system 100 includes a source device 102 and a destination device 116. Source device 102 provides encoded data to be decoded by a destination device 116. Particularly, in the example of FIG. 1, source device 102 provides the data to destination device 116 via a computer-readable medium 110. Source device 102 and destination device 116 may comprise any of a wide range of devices, including desktop computers, notebook (i.e., laptop) computers, tablet computers, set-top boxes, telephone handsets such as smartphones, televisions, cameras, display devices, digital media players, video gaming consoles, video streaming devices, terrestrial or marine vehicles, spacecraft, aircraft, robots, LIDAR devices, satellites, or the like. In some cases, source device 102 and destination device 116 may be equipped for wireless communication.

In the example of FIG. 1, source device 102 includes a data source 104, a memory 106, a V-DMC encoder 200, and an output interface 108. Destination device 116 includes an input interface 122, a V-DMC decoder 300, a memory 120, and a data consumer 118. In accordance with this disclosure, V-DMC encoder 200 of source device 102 and V-DMC decoder 300 of destination device 116 may be configured to apply the techniques of this disclosure related to displacement vector quantization. Thus, source device 102 represents an example of an encoding device, while destination device 116 represents an example of a decoding device. In other examples, source device 102 and destination device 116 may include other components or arrangements. For example, source device 102 may receive data from an internal or external source. Likewise, destination device 116 may interface with an external data consumer, rather than include a data consumer in the same device.

System 100 as shown in FIG. 1 is merely one example. In general, other digital encoding and/or decoding devices may perform the techniques of this disclosure related to displacement vector quantization. Source device 102 and destination device 116 are merely examples of such devices in which source device 102 generates coded data for transmission to destination device 116. This disclosure refers to a “coding” device as a device that performs coding (encoding and/or decoding) of data. Thus, V-DMC encoder 200 and V-DMC decoder 300 represent examples of coding devices, in particular, an encoder and a decoder, respectively. In some examples, source device 102 and destination device 116 may operate in a substantially symmetrical manner such that each of source device 102 and destination device 116 includes encoding and decoding components. Hence, system 100 may support one-way or two-way transmission between source device 102 and destination device 116, e.g., for streaming, playback, broadcasting, telephony, navigation, and other applications.

In general, data source 104 represents a source of data (i.e., raw, unencoded data) and may provide a sequential series of “frames”) of the data to V-DMC encoder 200, which encodes data for the frames. Data source 104 of source device 102 may include a mesh capture device, such as any of a variety of cameras or sensors, e.g., a 3D scanner or a light detection and ranging (LIDAR) device, one or more video cameras, an archive containing previously captured data, and/or a data feed interface to receive data from a data content provider. Alternatively or additionally, mesh data may be computer-generated from scanner, camera, sensor or other data. For example, data source 104 may generate computer graphics-based data as the source data, or produce a combination of live data, archived data, and computer-generated data. In each case, V-DMC encoder 200 encodes the captured, pre-captured, or computer-generated data. V-DMC encoder 200 may rearrange the frames from the received order (sometimes referred to as “display order”) into a coding order for coding. V-DMC encoder 200 may generate one or more bitstreams including encoded data. Source device 102 may then output the encoded data via output interface 108 onto computer-readable medium 110 for reception and/or retrieval by, e.g., input interface 122 of destination device 116.

Memory 106 of source device 102 and memory 120 of destination device 116 may represent general purpose memories. In some examples, memory 106 and memory 120 may store raw data, e.g., raw data from data source 104 and raw, decoded data from V-DMC decoder 300. Additionally or alternatively, memory 106 and memory 120 may store software instructions executable by, e.g., V-DMC encoder 200 and V-DMC decoder 300, respectively. Although memory 106 and memory 120 are shown separately from V-DMC encoder 200 and V-DMC decoder 300 in this example, it should be understood that V-DMC encoder 200 and V-DMC decoder 300 may also include internal memories for functionally similar or equivalent purposes. Furthermore, memory 106 and memory 120 may store encoded data, e.g., output from V-DMC encoder 200 and input to V-DMC decoder 300. In some examples, portions of memory 106 and memory 120 may be allocated as one or more buffers, e.g., to store raw, decoded, and/or encoded data. For instance, memory 106 and memory 120 may store data representing a mesh.

Computer-readable medium 110 may represent any type of medium or device capable of transporting the encoded data from source device 102 to destination device 116. In one example, computer-readable medium 110 represents a communication medium to enable source device 102 to transmit encoded data directly to destination device 116 in real-time, e.g., via a radio frequency network or computer-based network. Output interface 108 may modulate a transmission signal including the encoded data, and input interface 122 may demodulate the received transmission signal, according to a communication standard, such as a wireless communication protocol. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded data.

In some examples, source device 102 may output encoded data to file server 114 or another intermediate storage device that may store the encoded data generated by source device 102. Destination device 116 may access stored data from file server 114 via streaming or download. File server 114 may be any type of server device capable of storing encoded data and transmitting that encoded data to the destination device 116. File server 114 may represent a web server (e.g., for a website), a File Transfer Protocol (FTP) server, a content delivery network device, or a network attached storage (NAS) device. Destination device 116 may access encoded data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded data stored on file server 114. File server 114 and input interface 122 may be configured to operate according to a streaming transmission protocol, a download transmission protocol, or a combination thereof.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 comprise wireless components, output interface 108 and input interface 122 may be configured to transfer data, such as encoded data, according to a cellular communication standard, such as 4G, 4G-LTE (Long-Term Evolution), LTE Advanced, 5G, or the like. In some examples where output interface 108 comprises a wireless transmitter, output interface 108 and input interface 122 may be configured to transfer data, such as encoded data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to V-DMC encoder 200 and/or output interface 108, and destination device 116 may include an SoC device to perform the functionality attributed to V-DMC decoder 300 and/or input interface 122.

The techniques of this disclosure may be applied to encoding and decoding in support of any of a variety of applications, such as communication between autonomous vehicles, communication between scanners, cameras, sensors and processing devices such as local or remote servers, geographic mapping, or other applications.

Input interface 122 of destination device 116 receives an encoded bitstream from computer-readable medium 110 (e.g., a communication medium, storage device 112, file server 114, or the like). The encoded bitstream may include signaling information defined by V-DMC encoder 200, which is also used by V-DMC decoder 300, such as syntax elements having values that describe characteristics and/or processing of coded units (e.g., slices, pictures, groups of pictures, sequences, or the like). Data consumer 118 uses the decoded data. For example, data consumer 118 may use the decoded data to determine the locations of physical objects. In some examples, data consumer 118 may comprise a display to present imagery based on meshes.

V-DMC encoder 200 and V-DMC decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of V-DMC encoder 200 and V-DMC decoder 300 may be included in one or more encoders or decoders, either of which may be integrated as part of a combined encoder/decoder (CODEC) in a respective device. A device including V-DMC encoder 200 and/or V-DMC decoder 300 may comprise one or more integrated circuits, microprocessors, and/or other types of devices.

V-DMC encoder 200 and V-DMC decoder 300 may operate according to a coding standard. This disclosure may generally refer to coding (e.g., encoding and decoding) of pictures to include the process of encoding or decoding data. An encoded bitstream generally includes a series of values for syntax elements representative of coding decisions (e.g., coding modes).

This disclosure may generally refer to “signaling” certain information, such as syntax elements. The term “signaling” may generally refer to the communication of values for syntax elements and/or other data used to decode encoded data. That is, V-DMC encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

In V-DMC, the original mesh is pre-processed and then encoded using a base mesh/static-mesh encoder. The base mesh/static-mesh encoder encodes the connectivity of the mesh triangles as well as the attributes. These attributes may include position/geometry, color, texture, normals, etc. This disclosure proposes a fixed-point integer implementation of normal attribute encoding in the static mesh encoder within the V-DMC.

Working Group 7 (WG7), often referred to as the 3D Graphics and Haptics Coding Group (3DGH), is presently engaged in standardizing the video-based dynamic mesh coding (V-DMC) for XR applications. The current V-DMC software implementation is explained in Study of technologies for Video-based mesh coding, ISO/IEC JTC1/SC29/WG7, MDS24196_WG07_N00960, July 2024 (hereinafter “the CD document”) and V-DMC codec description, ISO/IEC JTC1/SC29/WG7, MDS23589_WG07_N00794, January 2024 (hereinafter, “the codec description”).

The current testing model TMM v9 and the CD document, derived from the April 2022 call for proposals, Khaled Mammou, Jungsun Kim, Alexandros Tourapis, Dimitri Podborski, Krasimir Kolarov, [V-CG] Apple's Dynamic Mesh Coding CfP Response, ISO/IEC JTC1/SC29/WG7, m59281, April 2022, involves preprocessing input meshes into possibly simplified versions called “base mesh.” This base mesh could contain fewer vertices and is encoded using a base mesh coder also called a static mesh coder. The preprocessing also generates displacement vectors as well as attribute map that are both separately encoded using a video encoder and/or arithmetic encoder. If the mesh is encoded in a lossless manner, then the base mesh is no longer a simplified version and is used to encode the original mesh. For the lossless manner, the V-DMC TMM v8.0 tool operates in intra-mode where the base mesh encoder becomes the primary encoding process.

The base mesh encoder encodes the connectivity of the mesh as well as the attributes associated with each vertex which typically involves the position and the texture coordinates (UV coordinates). The position may include 3D coordinates (x,y,z) of the vertex while the texture is stored as a 2D UV coordinate (u,v) also called texture coordinates that points to the texture map image pixel location. The base mesh in V-DMC is encoded using a certain implementation of Edgebreaker algorithm where the connectivity is encoded using a CLERS op code using Edgebreaker traversal and the residual of the attribute is encoded using prediction from the previously encoded/decoded vertices. The attributes for a mesh can be per-vertex or per-face.

A detailed description of the proposal that was selected as the starting point for the V-DMC standardization can be found in the '039 application, the '139 application, the '219 application, the CD document, the call for proposals, and the codec description.

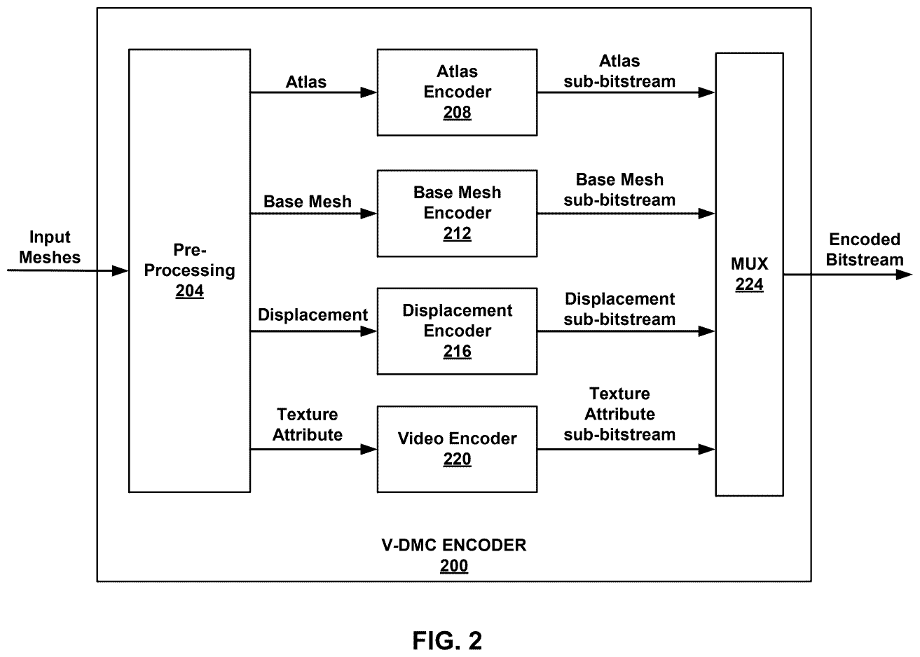

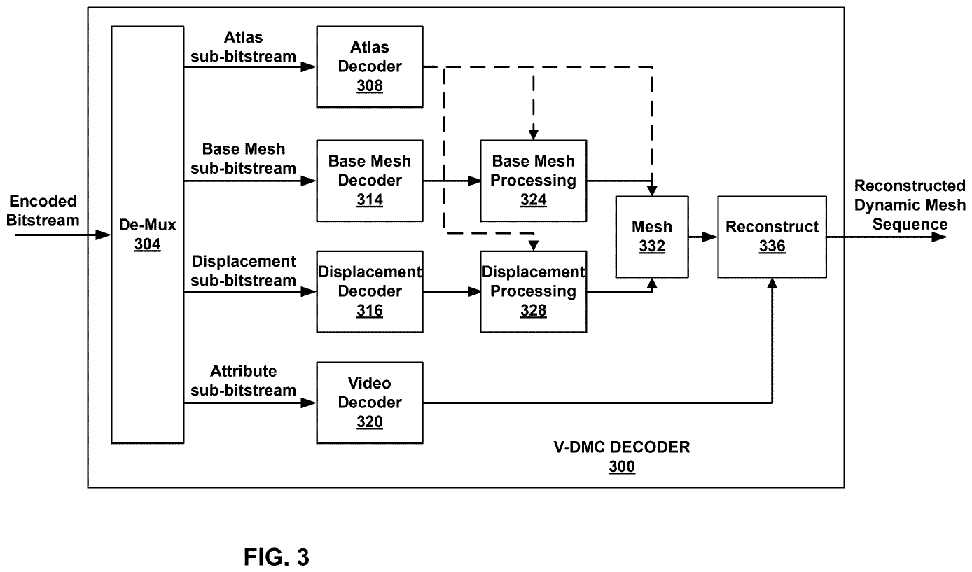

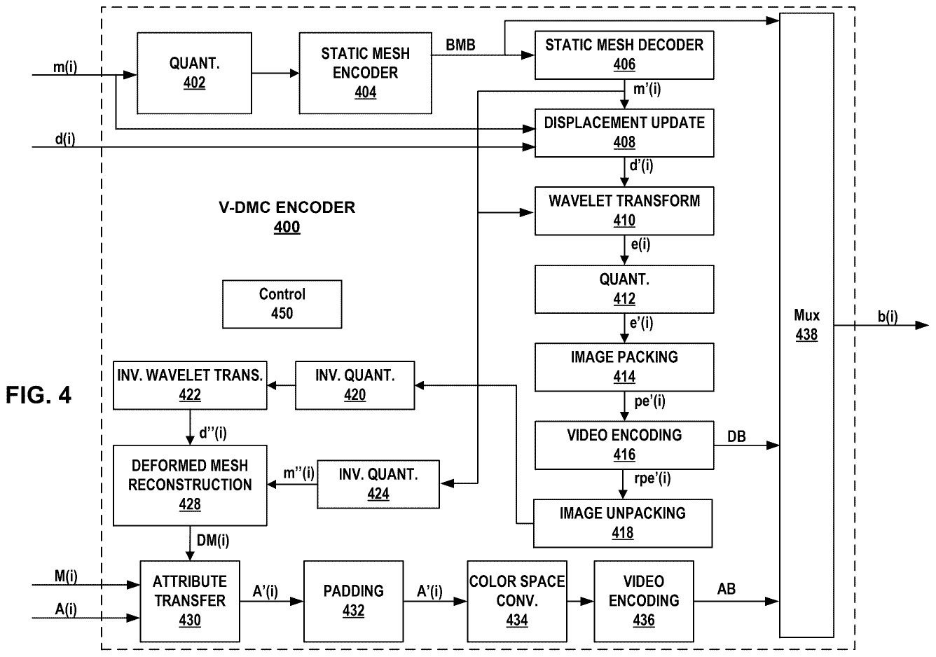

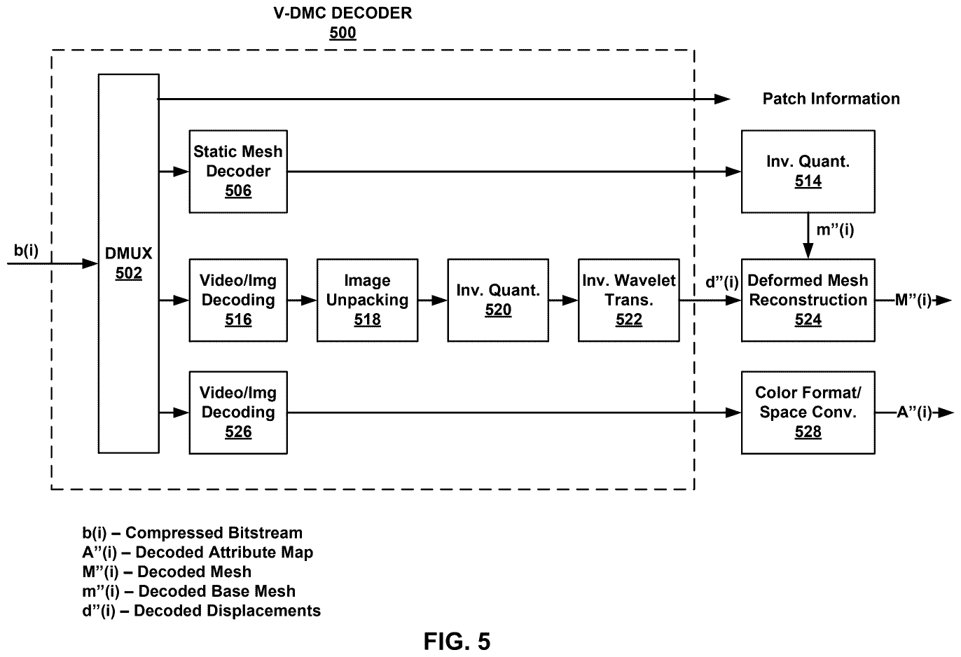

FIGS. 2 and 3 show the overall system model for the current V-DMC test model (TM) including the encoder and decoder architecture. FIG. 4 shows a more detailed view of a V-DMC encoder, and FIG. 5 shows a more detailed view of a V-DMC decoder.

The following is a brief overview of the system and explanation of the terms used throughout V-DMC:

Mesh: This is a 3D data storage format where the 3D data is represented in terms of triangles. The data includes triangle connectivity and the corresponding attributes.

Mesh Attributes: The attributes may include a lot of things per-vertex geometry (x,y,z), texture, per-vertex normals, per-vertex color, per-face color, per-face normals, etc.

Texture vs color: Texture is different from the color attribute. A color attribute includes per-vertex color whereas texture is stored as a texture map (image) and texture coordinates (UV coordinates). Each individual vertex is assigned a UV coordinate that corresponds to the (u,v) location on the texture map.

Texture encoding includes encoding both the per-vertex texture coordinates (UV coordinates) and the corresponding texture map. UV coordinates are encoded in the base mesh encoder/static mesh encoder while the texture map is encoded using a video encoder.

Preprocessing: The input mesh sequence first goes through the pre-processing to generate an atlas, base mesh, the displacement vectors, and the attribute maps.

Atlas Encoding: Atlas parameterizations include of packing 3D mesh into a 2D atlas, i.e., texture mapping. Atlas encoder encodes the information required to parameterize the 3D mesh into a 2D texture map.

Base Mesh/Static Mesh: For lossy encoding, the base mesh is sometimes a simplified mesh with possibly a smaller number of vertices. For lossless encoding, the base mesh is the original mesh with possible simplifications.

Base Mesh Encoder/Static Mesh Encoder: The base mesh is encoded using a base mesh encoder (referred to as static mesh encoder in FIG. 4). The base mesh encoder uses Edgebreaker to encodes the mesh connectivity and attributes (geometry, texture coordinates (UV coordinates), etc.) in a lossless manner.

Displacement Encoder: Displacements are per-vertex vectors that indicate how the base mesh is transformed/displaced to create the current frame's original mesh. The displacement vectors can be encoded as a Visual Volumetric Video-based Coding (V3C) video component or using arithmetic displacement coding.

Texture Map Encoder: A video encoder is employed to encode the texture map.

Lossless mode: In the lossless mode there are no displacement vectors and the base mesh is not simplified. The base mesh encoder is a lossless encoder so it is sufficient for lossless mode of V-DMC. The texture map is encoded using lossless video encoder. In the lossless mode, the V-DMC operates in all-intra mode.

Lossy mode: In the lossy mode, the base mesh could be a simplified version of the original mesh. Displacement vectors are employed to subdivide and displace the base mesh to obtain reconstructed mesh. The texture map is encoded using lossy video encoder.

Normals: The normals are not currently supported in the V-DMC TMM v7.0. Just like texture and color, the normals could also be per-vertex normal vector or could include the normal map with corresponding normal coordinates.

FIG. 2 shows an example implementation of V-DMC encoder 200. In the example of FIG. 2, V-DMC encoder 200 includes pre-processing unit 204, atlas encoder 208, base mesh encoder 212, displacement encoder 216, video encoder 220, and multiplexer (MUX) 224. Pre-processing unit 204 receives an input mesh sequence and generates atlas parameters, a base mesh, the displacement vectors, and the texture attribute maps. Atlas encoder 208 encodes the atlas parameters. Base mesh encoder 212 encodes the base mesh. Displacement encoder 216 encodes the displacement vectors, for example as V3C video components or using arithmetic displacement coding. Video encoder 220 encodes the texture attribute components, e.g., texture or material information, using any video codec, such as the High Efficiency Video Coding (HEVC) Standard or the Versatile Video Coding (VVC) standard. MUX 224 combines the atlas sub-bitstream produced by atlas encoder 208, the base mesh sub-bitstream produced by base mesh encoder 212, the displacement sub-bitstream produced by displacement encoder 216, and the texture attribute sub-bitstream produced by video encoder 220 into a single encoded bitstream that may be stored or transmitted.

Aspects of V-DMC encoder 200 will now be described in more detail. Pre-processing unit 204 represents the 3D volumetric data as a set of base meshes and corresponding refinement components. This is achieved through a conversion of input dynamic mesh representations into a number of V3C components: a base mesh, a set of displacements, a 2D representation of the texture map, and an atlas. The base mesh component is a simplified low-resolution approximation of the original mesh in the lossy compression and is the original mesh in the lossless compression. The base mesh component can be encoded by base mesh encoder 212 using any mesh codec.

Base mesh encoder 212 is represented as Static Mesh Encoder in FIG. 4 and employs an implementation of the Edgebreaker algorithm, e.g., m63344, for encoding the base mesh where the connectivity is encoded using a CLERS op code, e.g., from Rossignac and Lopes, and the residual of the attribute is encoded using prediction from the previously encoded/decoded vertices' attributes.

Aspects of base mesh encoder 212 will now be described in more detail. One or more submeshes are input to base mesh encoder 212. Submeshes are generated by pre-processing unit 204. Submeshes are generated from original meshes by utilizing semantic segmentation. Each base mesh may include one or more submeshes.

Base mesh encoder 212 may process connected components. Connected components include a cluster of triangles that are connected by their neighbors. A submesh can have one or more connected components. Base mesh encoder 212 may encode one “connected component” at a time for connectivity and attributes encoding and then performs entropy encoding on all “connected components”.

Base mesh encoder 212 defines and categorizes the input base mesh into the connectivity and attributes. The geometry and texture coordinates (UV coordinates) are categorized as attributes.

FIG. 3 shows an example implementation of V-DMC decoder 300. In the example of FIG. 3, V-DMC decoder 300 includes demultiplexer 304, atlas decoder 308, base mesh decoder 314, displacement decoder 316, video decoder 320, base mesh processing unit 324, displacement processing unit 328, mesh generation unit 332, and reconstruction unit 336.

Demultiplexer 304 separates the encoded bitstream into an atlas sub-bitstream, a base-mesh sub-bitstream, a displacement sub-bitstream, and a texture attribute sub-bitstream. Atlas decoder 308 decodes the atlas sub-bitstream to determine the atlas information to enable inverse reconstruction. Base mesh decoder 314 decodes the base mesh sub-bitstream, and base mesh processing unit 324 reconstructs the base mesh. Displacement decoder 316 decodes the displacement sub-bitstream, and displacement processing unit 328 reconstructs the displacement vectors. Mesh generation unit 332 modifies the base mesh based on the displacement vector to form a displaced mesh.

Video decoder 320 decodes the texture attribute sub-bitstream to determine the texture attribute map, and reconstruction unit 336 associates the texture attributes with the displaced mesh to form a reconstructed dynamic mesh.

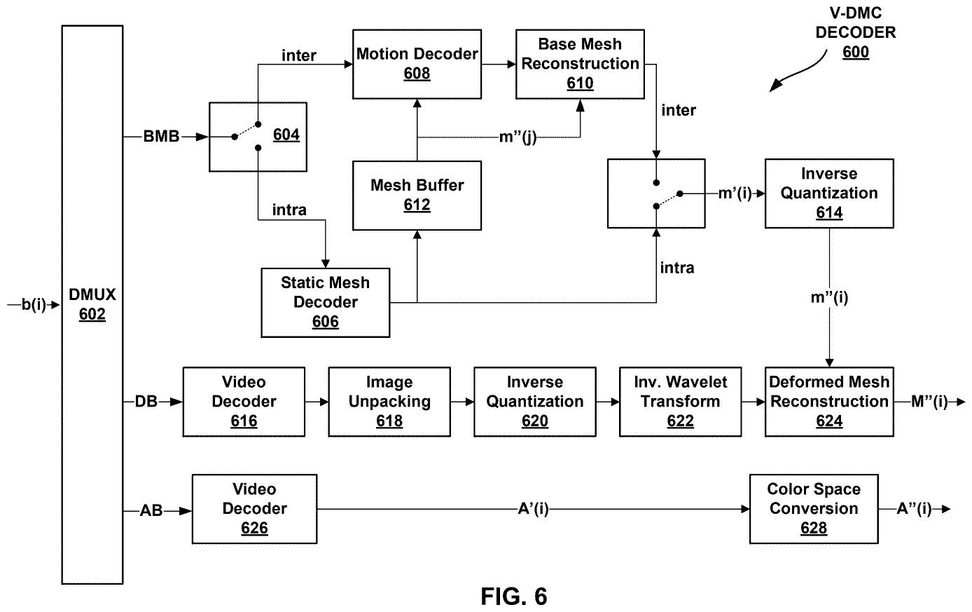

FIG. 4 shows intra-mode V-DMC encoder 400, and FIG. 5 shows an intra-mode V-DMC decoder 500. V-DMC encoder 400 generally represents a more detailed example implementation of V-DMC encoder 200, particularly with respect to intra-mode functionality, and V-DMC decoder 500 represents a more detailed example implementation of V-DMC decoder 300, particularly with respect to intra-mode functionality. FIG. 6 shows a V-DMC decoder 600, which represents a more detailed example implementation of V-DMC decoder 300, particularly with respect to intra-mode and inter-mode functionality.

FIGS. 4 and 6 include the following abbreviations:
m(i)—Base mesh
d(i)—Displacements
m″(i)—Reconstructed Base Mesh
d″(i)—Reconstructed Displacements
A(i)—Attribute Map
A′(i)—Updated Attribute Map
M(i)—Static/Dynamic Mesh
DM(i)—Reconstructed Deformed Mesh
m′(i)—Reconstructed Quantized Base Mesh
d′(i)—Updated Displacements
e(i)—Wavelet Coefficients
e′(i)—Quantized Wavelet Coefficients
pe′(i)—Packed Quantized Wavelet Coefficients
rpe′(i)—Reconstructed Packed Quantized Wavelet Coefficients
AB—Compressed attribute bitstream
DB—Compressed displacement bitstream
BMB—Compressed base mesh bitstream

In the example of FIG. 4, V-DMC encoder 400 receives base mesh m(i) and displacements d(i), for example from a pre-processing system. V-DMC encoder 400 also retrieves mesh M(i) and attribute map A(i).

Quantization unit 402 quantizes the base mesh, and static mesh encoder 404 encodes the quantized base mesh to generate a compressed base mesh bitstream. Static mesh decoder 406 then decodes the compressed bitstream. To the extent the encoding of the base mesh by static mesh encoder 404 is lossy, this encoding followed by decoding may determine the loss so that V-DMC encoder 400 may determine displacement vectors that reduce or minimize the loss.

Displacement update unit 408 uses the reconstructed quantized base mesh m′(i) to update the displacement field d(i) to generate an updated displacement field d′(i). This process considers the differences between the reconstructed base mesh m′(i) and the original base mesh m(i). By exploiting the subdivision surface mesh structure, wavelet transform unit 410 applies a wavelet transform to d′(i) to generate a set of wavelet coefficients. The scheme is agnostic of the transform applied and may leverage any other transform, including the identity transform. Quantization unit 412 quantizes wavelet coefficients, and image packing unit 414 packs the quantized wavelet coefficients into a 2D image/video that can be compressed using a traditional image/video encoder in the same spirit as V-PCC to generate a displacement bitstream.

Attribute transfer unit 430 converts the original attribute map A(i) to an updated attribute map that corresponds to the reconstructed deformed mesh DM(i). Padding unit 432 pads the updated attributed map by, for example, filling patches of the frame that have empty samples with interpolated samples that may improve coding efficiency and reduce artifacts. Color space conversion unit 434 converts the attribute map into a different color space, and video encoding unit 436 encodes the updated attribute map in the new color space, using for example a video codec, to generate an attribute bitstream.

Multiplexer 438 combines the compressed attribute bitstream, compressed displacement bitstream, and compressed base mesh bitstream into a single compressed bitstream.

Image unpacking unit 418 and inverse quantization unit 420 apply image unpacking and inverse quantization to the reconstructed packed quantized wavelet coefficients generated by video encoding unit 416 to obtain the reconstructed version of the wavelet coefficients. Inverse wavelet transform unit 422 applies an inverse wavelet transform to the reconstructed wavelet coefficient to determine reconstructed displacements d″(i).

Inverse quantization unit 424 applies an inverse quantization to the reconstructed quantized base mesh m′(i) to obtain a reconstructed base mesh m″(i). Deformed mesh reconstruction unit 428 subdivides m″(i) and applies the reconstructed displacements d″(i) to its vertices to obtain the reconstructed deformed mesh DM(i).

Image unpacking unit 418, inverse quantization unit 420, inverse wavelet transform unit 422, and deformed mesh reconstruction unit 428 represent a displacement decoding loop. Inverse quantization unit 424 and deformed mesh reconstruction unit 428 represent a base mesh decoding loop. Mesh encoder 400 includes the displacement decoding loop and the base mesh decoding loop so that mesh encoder 400 can make encoding decisions, such as determining an acceptable rate-distortion tradeoff, based on the same decoded mesh that a mesh decoder will generate, which may include distortion due to the quantization and transforms. Mesh encoder 400 may also use decoded versions of the base mesh, reconstructed mesh, and displacements for encoding subsequent base meshes and displacements.

Control unit 450 generally represents the decision making functionality of V-DMC encoder 400. During an encoding process, control unit 450 may, for example, make determinations with respect to mode selection, rate allocation, quality control, and other such decisions.

FIG. 5 shows a block diagram of an intra decoder which may, for example, be part of V-DMC decoder 300. De-multiplexer (DMUX) 502 separates compressed bitstream (bi) into a mesh sub-stream, a displacement sub-stream for positions and potentially for each vertex attribute, zero or more attribute map sub-streams, and an atlas sub-stream containing patch information in the same manner as in V3C/V-PCC.

De-multiplexer 502 feeds the mesh sub-stream to static mesh decoder 506 to generate the reconstructed quantized base mesh m′(i). Inverse quantization unit 514 inverse quantizes the base mesh to determine the decoded base mesh m″(i). Video/image decoding unit 516 decodes the displacement sub-stream, and image unpacking unit 518 unpacks the image/video to determine quantized transform coefficients, e.g., wavelet coefficients. Inverse quantization unit 520 inverse quantizes the quantized transform coefficients to determine dequantized transform coefficients. Inverse transform unit 522 generates the decoded displacement field d″(i) by applying the inverse transform to the unquantized coefficients. Deformed mesh reconstruction unit 524 generates the final decoded mesh (M″(i)) by applying the reconstruction process to the decoded base mesh m″(i) and by adding the decoded displacement field d″(i). The attribute sub-stream is directly decoded by video/image decoding unit 526 to generate an attribute map A″(i). Color format/space conversion unit 528 may convert the attribute map into a different format or color space.

FIG. 6 shows V-DMC decoder 600, which may be configured to perform either intra- or inter-decoding. V-DMC decoder 600 represents an example implementation of V-DMC decoder 300. The processes described with respect to FIG. 6 may also be performed, in full or in part, by V-DMC encoder 200.

V-DMC decoder 600 includes demultiplexer (DMUX) 602, which receives compressed bitstream b (i) and separates the compressed bitstream into a base mesh bitstream (BMB), a displacement bitstream (DB), and an attribute bitstream (AB). Mode select unit 604 determines if the base mesh data is encoded in an intra mode or an inter mode. If the base mesh is encoded in an intra mode, then static mesh decoder 606 decodes the mesh data without reliance on any previously decoded meshes. If the base mesh is encoded in an inter mode, then motion decoder 608 decodes motion, and base mesh reconstruction unit 610 applies the motion to an already decoded mesh (m″(j)) stored in mesh buffer 612 to determine a reconstructed quantized base mesh (m′(i))). Inverse quantization unit 614 applies an inverse quantization to the reconstructed quantized base mesh to determine a reconstructed base mesh (m″(i)).

Video decoder 616 decodes the displacement bitstream to determine a set or frame of quantized transform coefficients. Image unpacking unit 618 unpacks the quantized transform coefficients. For example, video decoder 616 may decode the quantized transform coefficients into a frame, where the quantized transform coefficients are organized into blocks with particular scanning orders. Image unpacking unit 618 converts the quantized transform coefficients from being organized in the frame into an ordered series. In some implementations, the quantized transform coefficients may be directly coded, using a context-based arithmetic coder for example, and unpacking may be unnecessary.

Regardless of whether the quantized transform coefficients are decoded directly or in a frame, inverse quantization unit 620 inverse quantizes, e.g., inverse scales, quantized transform coefficients to determine de-quantized transform coefficients. Inverse wavelet transform unit 622 applies an inverse transform to the de-quantized transform coefficients to determine a set of displacement vectors. Deformed mesh reconstruction unit 624 deforms the reconstructed base mesh using the decoded displacement vectors to determine a decoded mesh (M″(i)).

Video decoder 626 decodes the attribute bitstream to determine decoded attribute values (A′(i)), and color space conversion unit 628 converts the decoded attribute values into a desired color space to determine final attribute values (A″(i)). The final attribute values correspond to attributes, such as color or texture, for the vertices of the decoded mesh.

Base mesh encoding, also referred to as static mesh encoding, will now be described in more detail. The V-DMC software first represents the 3D volumetric data as a set of base mesh and its corresponding refinement components. This is achieved through first a conversion of input dynamic mesh representation into number of V3C components: a base mesh, a set of displacements, 2D representation of the attributes, and an atlas (as shown in FIGS. 2 and 3). The base mesh component could be a simplified low-resolution approximation of the original mesh. The base mesh component can be encoded using any mesh codec.

Base mesh encoding is referred to as static mesh encoding in FIG. 4 and employs a specific implementation of the Edgebreaker for encoding the base mesh where the connectivity is encoded using a CLERS op code and the attributes are encoded using prediction schemes from the previously encoded/decoded vertices and residual coding.

Base mesh encoder/static-mesh encoder input and pre-processing steps:

Submesh: The input to a base mesh encoder could be one or more submeshes. Submeshes are generated during the preprocessing step in V-DMC shown in FIG. 2. Submeshes are generated from original mesh by utilizing semantic segmentation. Each base mesh includes one or more submeshes.

Connected component in the base mesh encoder: connected component includes a cluster of triangles that are connected by their neighbors. A submesh can have one or more connected components. The current implementation of base mesh encoder encodes one “connected component” at a time for connectivity and attributes encoding and then performs entropy encoding on all “connected components”.

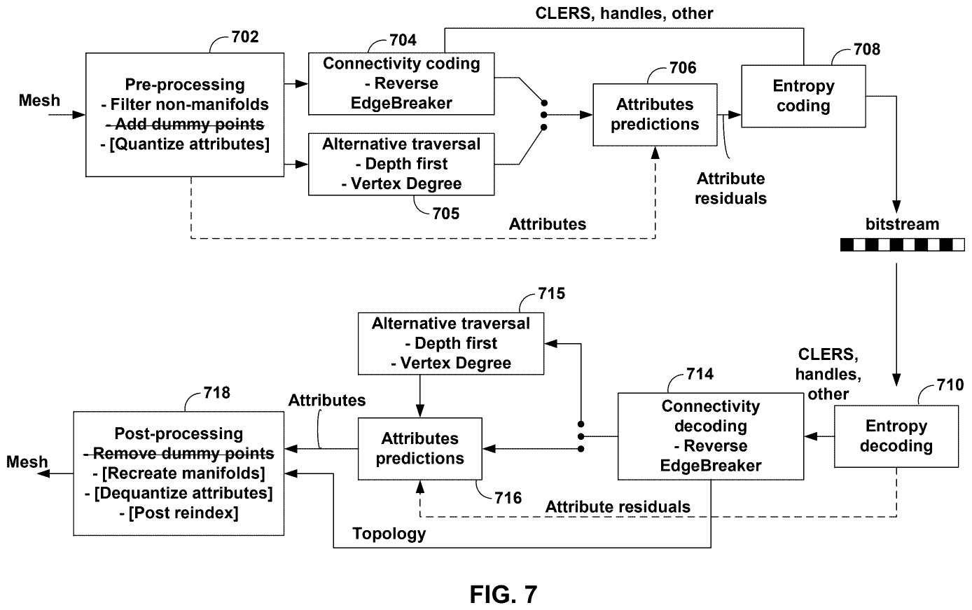

FIG. 7 is an overview of the complete Edgebreaker mesh codec. In FIG. 7, the top row is the encoding line, bottom row is the decoding line. FIG. 7 illustrates the end-to-end mesh codec based on Edgebreaker, which includes the following primary steps. The base mesh encoder defines and categorizes the input base mesh into the connectivity and attributes. The geometry and texture coordinates (UV coordinates) are categorized as attributes.

Encoding:
Pre-processing (702): Initially, a pre-processing is performed to rectify potential connectivity issues in the input mesh, such as non-manifold edges and vertices. The Edgebreaker algorithm employed may not operate with such connectivity problems. Addressing non-manifold issues may involve duplicating some vertices, which are tracked for later merging during decoding. This optimization reduces the number of points in the decoded mesh but necessitates additional information in the bitstream. Dummy points are also added in this pre-processing phase to fill potential surface holes, which Edgebreaker does not handle (shown as strike-through in FIG. 7). The holes are subsequently encoded by generating “virtual” dummy points by encoding dummy triangles attached to them, without requiring 3D position encoding. If needed, the vertex attributes are quantized in the pre-processing.
Connectivity Encoding (704): Next, the mesh's connectivity is encoded using a modified Edgebreaker algorithm, generating a CLERS table along with other memory tables used for attribute prediction. An alternative traversal may be possible with depth first and vertex degree (705).
Attribute Prediction (706): Vertex attributes are predicted, starting with geometry position attributes, and extending to other attributes, some of which may rely on position predictions, such as for texture UV coordinates.
Bitstream Configuration (708): Finally, configuration and metadata are included in the bitstream. This includes the entropy coding of CLERS tables and attribute residuals.

Decoding:
Entropy Decoding (710): The decoding process commences with the decoding of all entropy-coded sub-bitstreams.
Connectivity Decoding (714): Mesh connectivity is reconstructed using the CLERS table and the Edgebreaker algorithm, with additional information to manage handles that describe topology.
Attributes Predictions and Corrections (716), and possibly through alternative traversal (715): Vertex positions are predicted using the mesh connectivity and a minimal set of 3D coordinates. Subsequently, attribute residuals are applied to correct the predictions and obtain the final vertex positions. Other attributes are then decoded, potentially relying on the previously decoded positions, as is the case with UV coordinates. The connectivity of attributes using separate index tables is reconstructed using binary seam information that is entropy coded on a per-edge basis.
Post-processing (718): In a post-processing stage, dummy triangles are removed (shown as strike-through in FIG. 7.). Optionally, non-manifold issues are recreated if the codec is configured for lossless coding. Vertex attributes are also optionally dequantized if they were quantized during encoding.

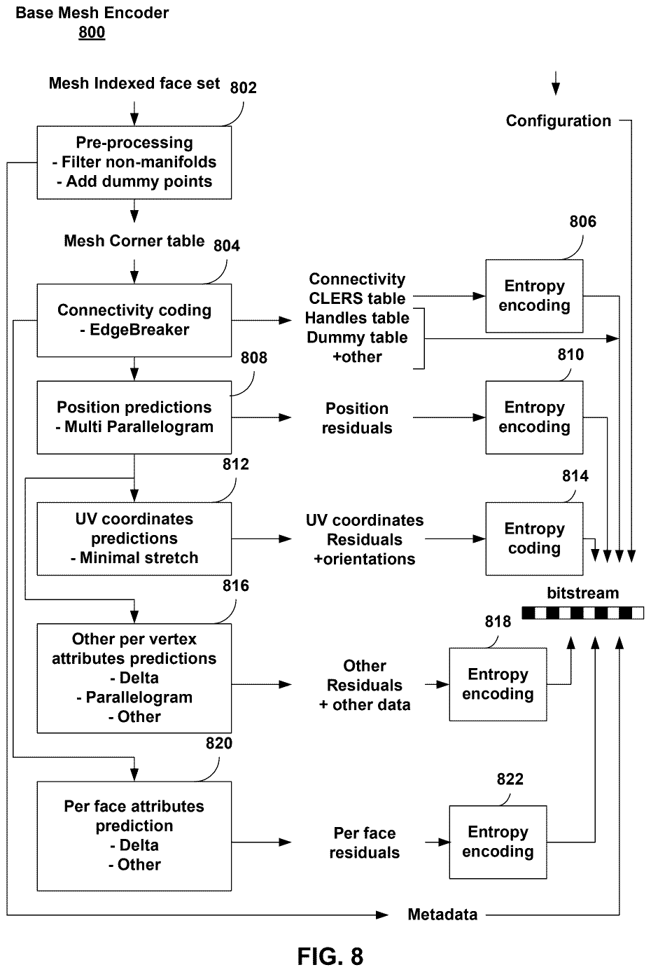

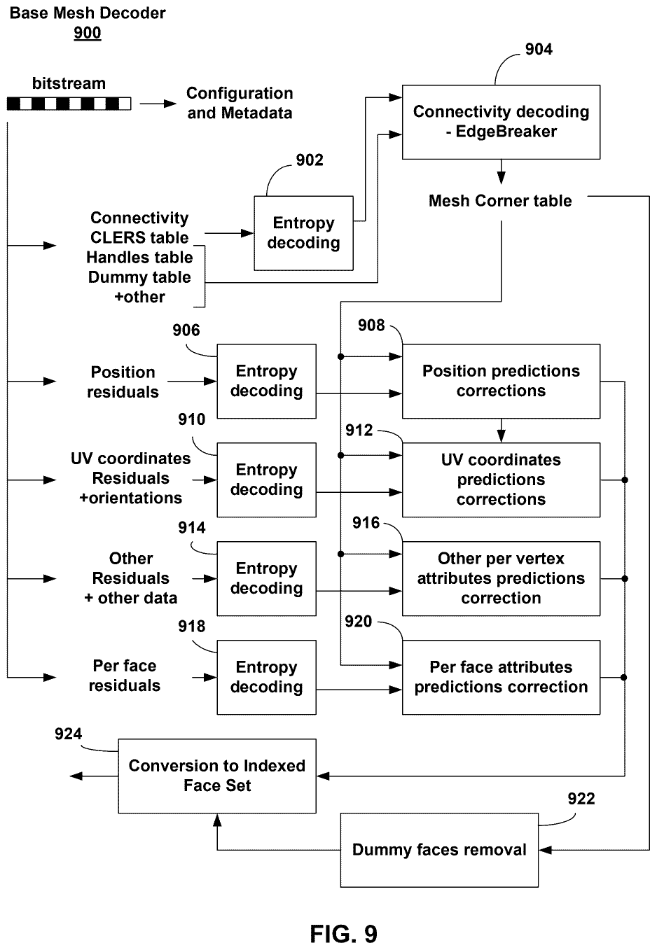

The encoder and decoder are further illustrated in FIGS. 8 and 9, respectively. FIG. 8 shows base mesh encoder 800, which represents an example implementation of base mesh encoder 212. FIG. 9 shows base mesh decoder 900, which represents an example implementation of base mesh decoder 314.

In the example of FIG. 8, base mesh encoder 800 receives a mesh indexed face set as input (802). The mesh indexed face set may be pre-processed to, for example, filter non-manifolds and add dummy points. After pre-processing, a mesh corner table is generated (804). From the mesh corner table, base mesh encoder 800 may perform connectivity coding (e.g., using Edgebreaker) to generate a connectivity CLERS table, a handles table, and a dummy table, which are then entropy encoded (806). Base mesh encoder 800 may perform position predictions using a multi-parallelogram process (808) to generate position residuals, which are then entropy encoded (810). Base mesh encoder 800 may generate UV coordinates predictions for texture coordinates using a minimal stretch process (812) to generate UV coordinates residuals and orientations, which are then entropy encoded (814). Base mesh encoder 800 may perform predictions for other per-vertex attributes (e.g., using delta or parallelogram prediction) (816) to generate other residual s and other data, which are then entropy encoded (818). Base mesh encoder 800 may perform per-face attributes prediction (e.g., using delta prediction) (820) to generate per-face residuals, which are then entropy encoded (822). The result of the entropy encoding processes, along with configuration data (806) and other metadata, may be combined into a bitstream that is then transmitted.

Base mesh decoder 900 of FIG. 9 may perform the reciprocal of base mesh encoder 800 of FIG. 8. For example, base mesh decoder 900 may receive encoded connectivity information, such as a CLERS table, a handles table, and a dummy table, which are then entropy decoded (902) so that connectivity decoding can be performed (904) to generate a mesh corner table. Base mesh decoder 900 may entropy decode (906) position residuals to perform position predictions corrections (908). Base mesh decoder 900 may entropy decode (910) UV coordinates residuals and orientations to perform UV coordinates predictions correction (912). Base mesh decoder 900 may entropy decode (914) other per-vertex residuals and other data to perform other per-vertex attributes predictions correction (916). Base mesh decoder 900 may entropy decode (918) per-face residuals to perform per-face attributes predictions corrections (920). Finally, base mesh decoder 900 may perform dummy faces removal (922) and generate a mesh indexed face set based on a conversion process (924).

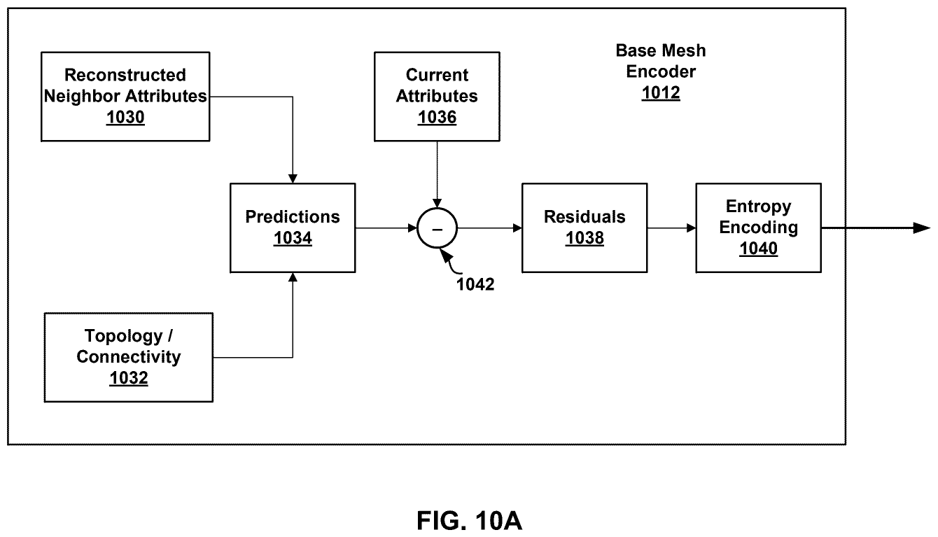

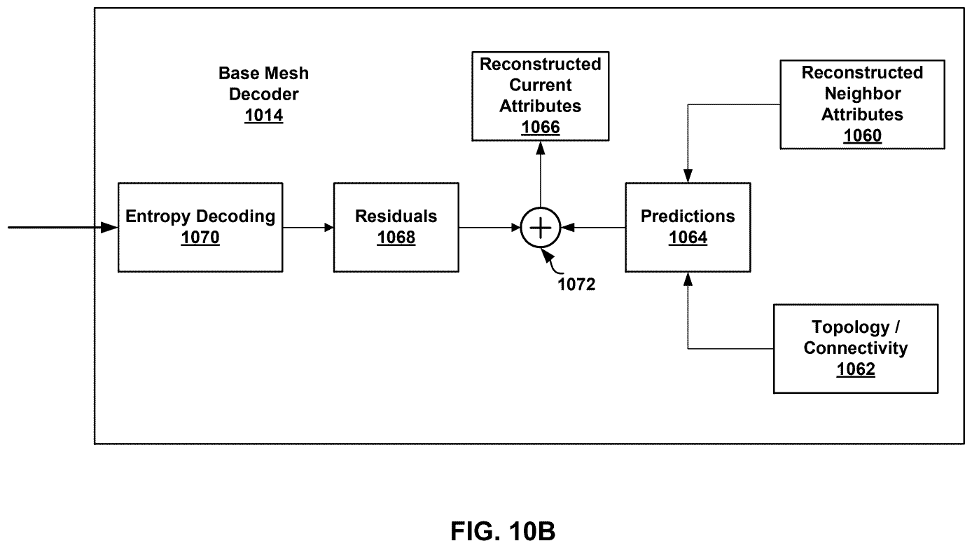

The following describes attribute coding in base mesh. FIGS. 10A and 10B show the encoder and decoder architecture for attribute encoding/decoding within the base mesh encoder (also referred to as static mesh encoder and/or Edgebreaker).

The base mesh encoder encodes both the attributes and the connectivity of the triangles and vertices. The attributes are typically encoded using a prediction scheme to predict the vertex attribute using previously visited/encoded/decoded vertices. Then the prediction is subtracted from the actual attribute value to obtain the residual. Finally, the residual attribute value is encoded using an entropy encoder to obtain the encoded base mesh attribute bitstream. The attribute bitstream which contains vertex attribute usually has the geometry/position attribute and the UV coordinates (texture attribute) but can contain any number of attributes like per-vertex RGB values, etc.

The attribute encoding procedure in the base mesh encoder is shown in FIG. 10A and includes:
Topology/Connectivity: The topology in the base mesh is encoded through the Edgebreaker using the CLERS op code. This contains not just the connectivity information but also the data structure for the mesh (current implementation employs corner table). The topology/connectivity information is employed to find the neighboring vertices.
Attributes: These include Geometry (3D coordinates), UV Coordinates (Texture), Normals, RGB values, etc.
Neighboring attributes: These are the attributes of the neighboring vertices that are employed to predict the current vertex's attribute.
Current attribute: This is the attribute of the current vertex that is being encoded/decoded. The attribute of the current vertex is typically predicted using neighboring attributes. Then the residual of the current vertex attribute is encoded.
Predictions: These predictions could be obtained from the connectivity and/or from the previously visited/encoded/decoded vertices. E.g., multi-parallelogram process for geometry, min stretch scheme for UV coordinates, etc. Each attribute could have their own prediction schemes.
Residuals: These are obtained by subtracting the predictions from original attributes. (e.g., residuals current vertex attribute predicted attribute)
Entropy Encoding: Finally, the Residuals are entropy encoded to obtain the bitstream.

FIGS. 10A and 10B show an encoder and decoder architecture for base mesh encoding/decoding (also referred to as static mesh encoding/decoding). FIG. 10A shows base mesh encoder 1012, which represents an example implementation of base mesh encoder 212 in FIG. 2, and FIG. 10B shows base mesh decoder 1014, which represents an example implementation of base mesh decoder 314 in FIG. 3.

In the example of FIG. 10A, base mesh encoder 1012 determines reconstructed neighbor attributes 1030 and topology/connectivity information 1032 to determine predictions 1034. Base mesh encoder 1012 subtracts (1042) predictions 1034 from current attributes 1036 to determine residuals 1038. Reconstructed neighbor attributes 1030 represent the decoded values of already encoded vertex attributes, and current attributes 1036 represent the actual values of unencoded vertex attributes. Thus, residuals 1038 represent the differences between actual values of unencoded vertex attributes and predicted values for those vertex attributes. Base mesh encoder 1012 may entropy encode (1040) residuals 1038.

In the example of FIG. 10B, base mesh decoder 1014 determines reconstructed neighbor attributes 1060 and topology/connectivity information 1062 to determine predictions 1064 in the same manner that base mesh encoder 1012 determines predictions 1034. Base mesh decoder 1014 entropy decodes (1070) the entropy encoded residual values to determine residuals 1068. Base mesh decoder 1014 adds (1072) predictions 1064 to residuals 1068 to determine reconstructed current attributes 1066. Reconstructed current attributes 1066 represent the decoded versions of current attributes 1036.

Attribute coding uses a prediction scheme to find the residuals between the predicted and actual attributes. Finally, the residuals are entropy encoded into a base mesh attribute bitstream. Each attribute is encoded differently. The geometry for 3D position and the UV coordinates for the texture are both encoded using prediction processes. To compute these predictions, the multi-parallelogram technique is utilized for geometry encoding while the min stretch process is employed for UV coordinates encoding.

The normals are encoded by using either multi-parallelogram prediction, Cross prediction, or delta prediction and then optionally encoded using octahedral representation, as described in the '039 application, the '139 application, the '219 application.

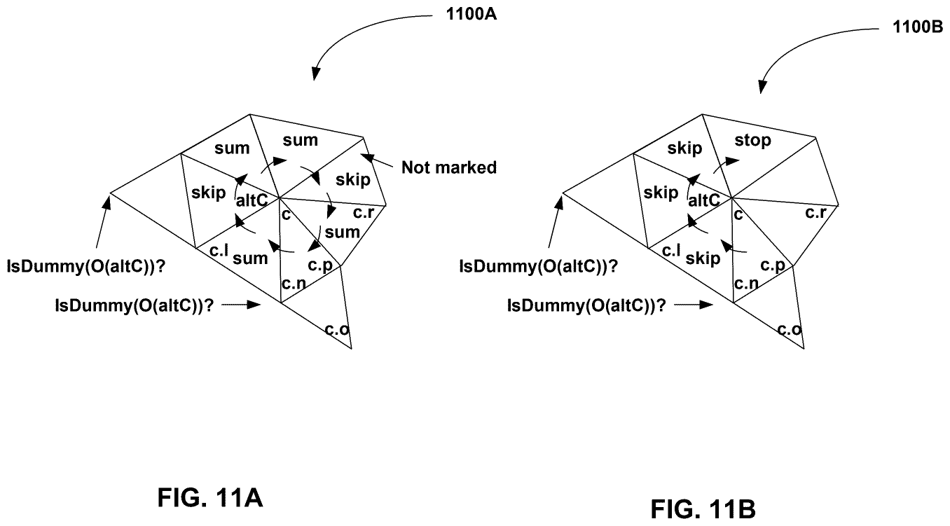

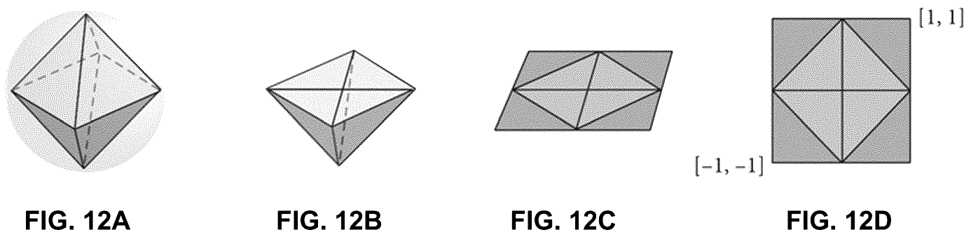

The process of calculating position predictions for a corner and its associated vertex index within the coding chain is outlined in FIGS. 11A and 11B. FIGS. 11A and 11B show both the multi-parallelogram approach for geometry and the min stretch technique for UV coordinates (texture). During the prediction of a vertex attributes, the triangle fan surrounding the vertex can be utilized to predict the current vertex's attributes. In FIGS. 11A and 11B, c, is the current corner, c.n is the next corner, c.p is the previous corner and c.o is the opposite corner.

Fan 1100A of FIG. 11A shows a process for multi-parallelogram prediction of corner c positions and dummy points filtering. Fan 1100B of FIG. 11B shows a process for min stretch prediction of corner c UV coordinates and dummy points filtering.

For position prediction, multi-parallelogram is employed. The processing of the multi-parallelogram for a given corner involves performing a lookup all around its vertex to calculate and aggregate each parallelogram prediction, utilizing opposite corners, as shown in FIGS. 11A and 11B. A parallelogram used to predict a corner from a sibling corner is considered valid for prediction only if the vertices of the corner itself, the sibling corner, and their shared vertex have been previously processed by the connectivity recursion, which triggers the prediction. To verify this condition, the vertex marking table (designated as M) is employed. This table contains elements set to true for vertices that have already been visited by the connectivity encoding loop. In the parallelogram prediction, the parallelogram moves in an anti-clockwise (or clockwise) direction by swinging around the “triangle fan”. If in a parallelogram, the next, previous, and opposite vertices are available, then that parallelogram (and the three other vertices) is used to predict the current vertices' position.

At the end of the loop, the sum of predictions is divided by the number of valid parallelograms that have been identified. The result is rounded and subsequently used to compute the residual (position-predicted), which is appended to the end of the output vertices table. In cases where no valid parallelogram is found, a fallback to delta coding is employed.

For UV coordinate predictions, min-stretch prediction is employed. For encoding predictions of UV coordinates, the procedure follows a similar extension to that used for positions. A distinction lies in the utilization of the min stretch approach rather than multi-parallelogram for prediction. Additionally, predictions are not summed up; instead, the process halts at the first valid (in terms of prediction) neighbor within the triangle fan, and the min stretch is computed, as depicted in FIGS. 11A and 11B.

Note: The V-DMC tool has also added support for multiple attributes where a mesh can have more than one texture map. Similarly, base mesh encoder also has support added for separate index for UV coordinates. In this case the UV Coordinates do not have to be in the same order as the position (primary attribute).

FIG. 11A shows a process for multi-parallelogram prediction of corner c positions and dummy points filtering. FIG. 11B shows a process for min stretch prediction of corner c UV coordinates and dummy points filtering.

V-DMC encoder 200 and V-DMC decoder 300 may be configured to process normal vectors. A normal vector, often simply called a “normal” to a surface, is a vector which is perpendicular to the surface at a given point. For a mesh, a normal can be a per-vertex normal or a per-face normal. The normal for a vertex or a face is sometimes provided as a “unit vector” that is normalized. These normals are typically in cartesian coordinates expressed with (x,y,z). 3D normals can be parameterized onto a 2D coordinate system to decrease the amount of data required to represent a normal.

Octahedral representation will now be described. While storing cartesian coordinates in float vector representation is convenient for computing with unit vectors, it falls short in terms of storage efficiency. Not only does it consume large bytes of memory, but it can also represent 3D direction vectors of arbitrary lengths. Normalized vectors are a small subset of all the possible 3D direction vectors and hence can be represented by a smaller representation.

An alternative approach is to use spherical coordinates. Doing so may reduce the required storage to just two floats. However, this comes with a trade-off: converting between 3D cartesian and spherical coordinates involves relatively expensive trigonometric and inverse trigonometric functions. Additionally, spherical coordinates offer more precision near the poles and less near the equator, which may not be ideal for uniformly distributed unit vectors.

The Octahedral representation provides a compact storage format for unit vectors, distributing precision evenly across all directions. It uses less memory per unit vector, and all possible values correspond to valid unit vector. Octahedral is an attractive choice for in-memory storage of normalized vectors due to its easy conversion to and from 3D cartesian coordinate vectors.

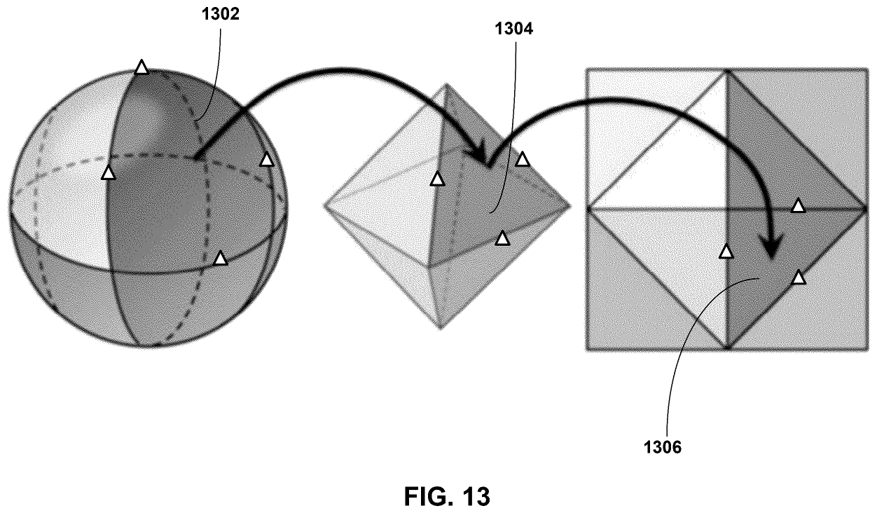

FIGS. 12A-12D illustrate how a 3D unit vector can be converted to a 2D octahedral representation. The first step is to project the vector onto the faces of the 3D octahedron (FIG. 12A). This can be done by dividing the vector components by the vector's L1 norm. For points in the upper hemisphere (i.e., with z>0), projection down to the z=0 plane is then achieved by taking the x and y components directly, as shown in FIG. 12B. For directions in the lower hemisphere, the reprojection to the appropriate point in [−1, +1]² may be slightly more complex. The negative z-hemisphere is reflected over the appropriate diagonal as shown in FIG. 12C. This results in 3D unit points within a [−1, +1]² square as shown in FIG. 12D.

FIG. 13 shows the implementation of normal encoding using octahedral representation in base mesh/static mesh encoder within V-DMC. In the example of FIG. 13, edges of area 1302, area 1304 and area 1306 are marked out by small triangles, and area 1302 in the sphere maps to area 1304 in the 3D octahedral, which then maps to area 1306 on the 2D octahedral representation. These areas would be warped to a much farther distance in the 2D octahedral representation. This increase in distance between the prediction and the original may lead to a higher residual.

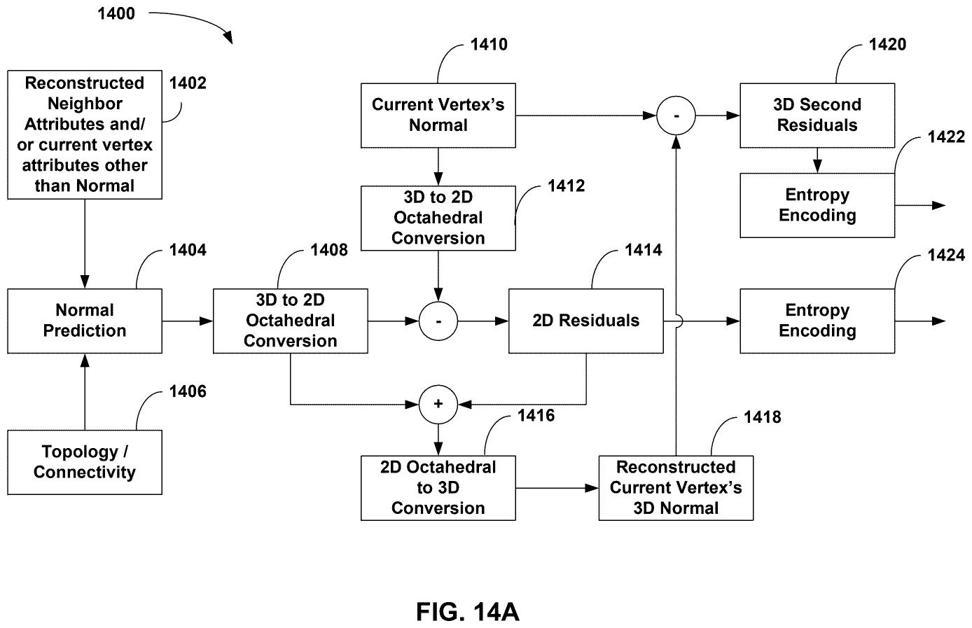

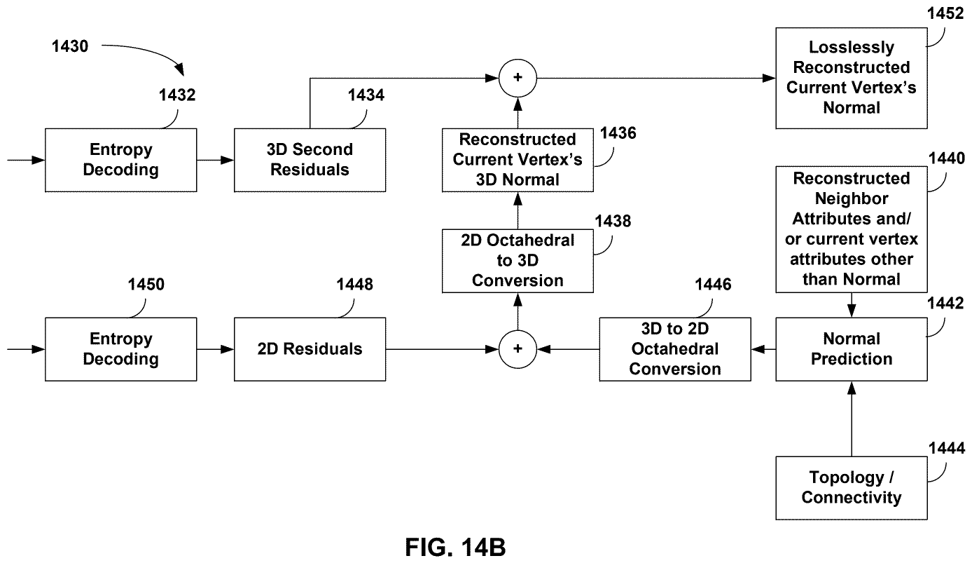

FIG. 14A illustrates base mesh encoder 1400, and FIG. 14B illustrates base mesh decoder 1430. As described in more detail, base mesh encoder 1400 and base mesh decoder 1430 may be configured to determine a 2D octahedral representation of a prediction vector for predicting a 2D octahedral representation of a 3D normal vector of a current vertex of the base mesh, and encode or decode the 3D normal vector of the current vertex based on the 2D octahedral representation of the prediction vector. Although the examples are described with respect to a current vertex, the examples are also applicable to a current face. The current face may be a polygon (e.g., triangle), where the interconnection of the polygons form the base mesh, and 3D normal vector for the current face may extend from a point on the current face (e.g., midpoint).

For example, base mesh encoder 1400 may determine one or more 3D normal vectors of previously encoded vertices of the base mesh, or determine one or more attributes, excluding normal vectors, of previously encoded vertices of the base mesh. For instance, the current vertex's normal is predicted using a normal prediction scheme that employs the topology/connectivity of the triangles (1406), the attributes of the neighboring vertices (1402), and the attributes other than a normal vector of the current vertex (1402).

Base mesh encoder 1400 may generate a 3D prediction vector (1404). As one example, base mesh encoder 1400 may generate a 3D prediction vector based on the one or more 3D normal vectors of previously encoded vertices of the base mesh (e.g., normal vectors of one or more neighboring vertices). As another example, base mesh encoder 1400 may generate a 3D prediction vector based on the one or more attributes of the previously encoded vertices and the one or more attributes of the current vertex. Example techniques to generate the 3D prediction vector are described in more detail below.

Both the 3D prediction of the normal and the actual value of the normal are then converted to a 2D representation using “3D to 2D octahedral conversion.” For example, base mesh encoder 1400 may determine the 2D octahedral representation of the prediction vector based on the 3D prediction vector (1408). For instance, base mesh encoder 1400 may convert the 3D prediction vector into the 2D octahedral representation of the prediction vector using the example techniques described above for converting from 3D to 2D octahedral representation.

In addition, base mesh encoder 1400 may access the 3D normal vector of a current vertex of the base mesh (1410). Base mesh encoder 1400 may convert the 3D normal vector of the current vertex to the 2D octahedral representation of the 3D normal vector of the current vertex using the example techniques described above for converting from 3D to 2D octahedral representation (1412).

Both the 2D prediction and 2D original normal are subtracted to find the 2D residual. For example, base mesh encoder 1400 may generate residual information (1414) indicative of a difference between the 2D octahedral representation of the 3D prediction vector (1408) and the 2D octahedral representation of the 3D normal vector of the current vertex (1412). The 2D residual is entropy encoded and stored in the bitstream. That is, base mesh encoder 1400 may signal the residual information after entropy encoding (1424).

Since the “3D to 2D” and “2D to 3D” conversions are lossy, and base mesh encoder 1400 may be a lossless encoder, there may be encoding of a second residual that includes any difference/losses in the conversions. For the second residual, there may be reconstruction of the 3D current vertex's normal and subtraction of it from the original 3D normal to obtain a 3D second residual that is entropy encoded and stored in the bitstream.

That is, base mesh encoder 1400 may reconstruct a 3D lossy representation of the normal vector of the current vertex (1418) based on adding the first residual information (1414) to the 2D octahedral representation of the prediction vector (1408), and converting a result of the adding from 2D octahedral representation (1416) to reconstruct the 3D lossy representation of the normal vector. Another example way in which base mesh encoder 1400 may reconstruct a 3D lossy representation of the normal vector of the current vertex (1418) is by converting the 2D octahedral representation of the 3D normal vector of the current vertex (1412) back to 3D to reconstruct the 3D lossy representation of the normal vector (1418).

Base mesh encoder 1400 may generate second residual information (1420) indicative of a difference between the 3D normal vector (1410) and the 3D lossy representation of the normal vector (1418). Base mesh encoder 1400 may signal the second residual information after entropy encoding (1422).

The decoder follows the inverse step to reconstruct the original normal in a lossless manner. For instance, in FIG. 14B, base mesh decoder 1430 may, after entropy decoding (1450), receive residual information (1448) indicative of a difference between the 2D octahedral representation of a prediction vector and a 2D octahedral representation of a 3D normal vector of a current vertex of a base mesh. Base mesh decoder 1430 may also determine a 2D octahedral representation of a prediction vector (1446) for predicting a 2D octahedral representation of a three-dimensional (3D) normal vector of a current vertex of the base mesh.

For example, base mesh decoder 1430 may determine one or more 3D normal vectors of previously decoded vertices of the base mesh, or determine one or more attributes, excluding normal vectors, of previously decoded vertices of the base mesh. For instance, the current vertex's normal is predicted using a normal prediction scheme that employs the topology/connectivity of the triangles (1444), the attributes of the neighboring vertices (1440), and the attributes other than normal vector of the current vertex (1440).

Base mesh decoder 1430 may generate a 3D prediction vector (1442). As one example, base mesh decoder 1430 may generate a 3D prediction vector based on the one or more 3D normal vectors of previously decoded vertices of the base mesh (e.g., normal vectors of one or more neighboring vertices). As another example, base mesh decoder 1430 may generate a 3D prediction vector based on the one or more attributes of the previously decoded vertices and the one or more attributes of the current vertex. Example techniques to generate the 3D prediction vector are described in more detail below.

Base mesh decoder 1430 may add the residual information (1448) to the 2D octahedral representation of the prediction vector (1446) to reconstruct the 2D octahedral representation of the 3D normal vector of the current vertex. Base mesh decoder 1430 may reconstruct the 3D normal vector of the current vertex from the 2D octahedral representation of the 3D normal vector of the current vertex (1436). For example, base mesh decoder 1430 may convert 2D octahedral representation to 3D (1438) using the example techniques described above.

The 3D normal vector may be a 3D lossy representation of the normal vector of the current vertex since 3D to 2D conversion or 2D to 3D conversion is lossy. In examples where lossless decoding is desired, base mesh decoder 1430 may, after entropy decoding (1432), receive second residual information (1434) indicative of a difference between the 3D normal vector of the current vertex and a 3D lossy representation of the normal vector of the current vertex. Base mesh decoder 1430 may add the second residual information (1434) to the 3D lossy representation of the normal vector of the current vertex (1436) to reconstruct the 3D normal vector (1452).

A fixed-point implementation of normal in static mesh encoding within V-DMC will now be described. The '039 application proposed the integration of normal vector encoding in V-DMC Test Model v6.0 (TMM v6.0) that was later ported to TMM v7.0. The '219 application proposes improvements to the encoding of normals by introducing a 2D octahedral representation for normals that was integrated into TMM v8.0. However, these previous implementations were in floats and involved floating-point calculations, which could lead to precision errors along with performance and implementation issues.

This disclosure proposes a fixed-point integer implementation of normal vector encoding. This disclosure will describe the normal prediction schemes as well as the octahedral representation using a fixed-point integer implementation. The processes described herein may not be restricted to the prediction algorithms mentioned above, but also include other prediction schemes.

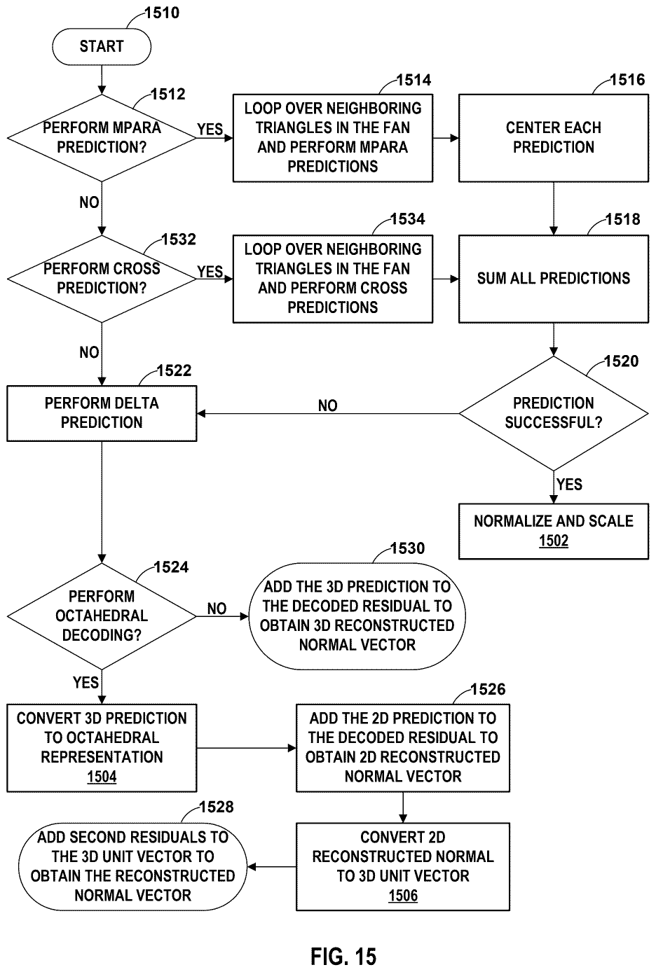

The normal encoding schemes using fixed-point integer implementation are shown in FIG. 15. The process loops around the fan to make predictions using neighboring vertices/triangles. If none of the neighboring vertices/triangles are available and/or visited before than the prediction is unsuccessful. If the predictions are successful, then the predictions are normalized and scaled to the proper bit depth. If the predictions are unsuccessful, then Delta prediction may be used. If octahedral conversion is not enabled, then the prediction is summed with the decoded residual to obtain the reconstructed normal as shown in FIGS. 10A and 10B. If the octahedral conversion is enabled, then FIG. 14 may be followed. The prediction is converted to 2D octahedral representation and then summed with the decoded residual to obtain 2D reconstructed normal. The 2D reconstructed normal is then converted to 3D unit vector. The 3D unit vector is then summed with the second residuals to obtain the reconstructed normal vector.

For fixed-point integer implementation, “normalization and scaling,” “2D to 3D conversion,” and “3D to 2D conversion” functions are formulated using a fixed-point integer implementation. These are shown in FIG. 15 in blocks 1502, 1504, and 1506. The mathematical formulation of the steps of Normalize and Scale the Prediction, Octahedral Conversion/Encoding, 3D to 2D Conversion, and 2D to 3D conversion are discussed below.

FIG. 15 is a flowchart of a normal decoding process performed by V-DMC decoder 300. V-DMC decoder 300 starts the process (1510) and determines whether to perform a multi-parallelogram (MPARA) prediction (1512). If V-DMC decoder 300 selects MPARA prediction, V-DMC decoder 300 loops over neighboring triangles to perform MPARA prediction (1514) and centers each prediction (1516). If V-DMC decoder 300 does not perform MPARA prediction, V-DMC decoder 300 determines whether to perform a cross prediction (1532). If V-DMC decoder 300 selects cross prediction, V-DMC decoder 300 loops over neighboring triangles to perform cross-product predictions (1534).

Following either the MPARA or cross prediction path, V-DMC decoder 300 sums all predictions (1518). V-DMC decoder 300 then determines if the predictions were successful (1520). If the predictions were not successful, or if V-DMC decoder 300 initially selected neither MPARA nor cross prediction, V-DMC decoder 300 performs a delta prediction (1522). If the predictions were successful, V-DMC decoder 300 normalizes and scales the result (1502).

After either the normalization and scaling step or the delta prediction step, V-DMC decoder 300 determines whether to perform octahedral decoding (1524). If octahedral decoding is not performed, V-DMC decoder 300 adds the 3D prediction to a decoded residual to obtain a 3D reconstructed normal vector (1530).

If V-DMC decoder 300 performs octahedral decoding, V-DMC decoder 300 converts the 3D prediction to a 2D octahedral representation (1504). V-DMC decoder 300 then adds this 2D prediction to a decoded residual to obtain a 2D reconstructed normal vector (1526). V-DMC decoder 300 converts the 2D reconstructed normal to a 3D unit vector (1506) and adds second residuals to the 3D unit vector to obtain the final reconstructed normal vector (1528).

V-DMC encoder 200 and V-DMC decoder 300 may be configured to normalize and scale the prediction. The input is a signed 3D vector vᵢₙ and the output is a normalized and scaled unsigned 3D vector vₒᵤₜ with bitdepth qn.

$${v}_{out} = \frac{( normalize ( {v}_{in} ) - min )}{max - min} * ( {2}^{qn} - 1 )$$

Where min and max are the minimum and maximum value of the normalize(vᵢₙ) 3D vector which should be −1 and 1 respectively. This makes the equation into:

$${v}_{out} = \frac{( normalize ( {v}_{in} ) + 1 )}{2} * ( {2}^{qn} - 1 )$$

$$where$$

$$normalize ( {v}_{in} ) = N = \frac{{v}_{in}}{sqrt ( ( {v}_{in} \cdot x * {v}_{in} \cdot x ) + ( {v}_{in} \cdot y * {v}_{in} \cdot y ) + ( {v}_{in} \cdot z * {v}_{in} \cdot z ) )}$$

Where vᵢₙ·x, vᵢₙ·y, and vᵢₙ·z are the components of vᵢₙ. To convert this into a fixed-point integer representation, the IntRecipSqrt(x) implementation that is explained in detail in the mathematical functions may be used. The function IntRecipSqrt(x) is a 40-bit fixed-point approximation of the reciprocal square root of x. Let s=40, so the equation becomes:

$${v}_{out} = \frac{( {v}_{in} * IntRecipSqrt ( Dot ( {v}_{in} , {v}_{in} ) ) + 1 * {2}^{s} )}{2} * ( {2}^{qn} - 1 ) \div {2}^{s}$$

Let N=vᵢₙ*IntRecipSqrt(Dot(vᵢₙ,vᵢₙ). Equation can be simplified to the following in fixed-point integer implementation:

$${v}_{out} = ( ( N + ( 1 ≪ s ) ) ≫ 1 ) * ( {2}^{qn} - 1 ) \div {2}^{s}$$

$${v}_{out} = ( ( ( N + ( 1 ≪ s ) ) ≪ ( qn - 1 ) ) - ( ( N + ( 1 ≪ s ) ) ≫ 1 ) ) ≫ s$$

Adding rounding to the above equation gives us the final output:

$${v}_{out} = ( ( ( N + ( 1 ≪ s ) ) ≪ ( qn - 1 ) ) - ( ( N + ( 1 ≪ s ) + 1 ) ≫ 1 ) + ( 1 ≪ ( s - 1 ) ) ) ≫ s$$

The above equation is the one implemented in the prediction of per-vertex normal vector attributes and TABLE 1.

V-DMC encoder 200 and V-DMC decoder 300 may be configured to perform octahedral conversion and encoding. The octahedral conversion includes 3D to 2D conversion as well as a 2D to 3D conversion. The encoding and decoding process are shown in Table 4 and the decode octahedral normal section, respectively.

V-DMC encoder 200 and V-DMC decoder 300 may be configured to 3D-to-2D conversion. The input is an unsigned 3D vector vᵢₙ and the output is a normalized and scaled unsigned 2D vector vₒᵤₜ with bitdepth qpOcta. At first the input is converted to a signed vector:

$${v}_{0} = {v}_{in} - center$$

Where the center is the three-dimensional point defining the middle point (center point) of the normal 3D representation vᵢₙ. Then the 3D vector is mapped to a 2D Octahedral space:

$${v}_{1} = \frac{{v}_{0}}{abs ( {v}_{in} \cdot x ) + abs ( {v}_{in} \cdot y ) + abs ( {v}_{in} \cdot z )}$$

$$If {v}_{1} is negative , then :$$

$${v}_{2} \cdot x = 1 - {v}_{1} \cdot y * CopySign ( {v}_{1} \cdot x )$$

$${v}_{2} \cdot y = 1 - {v}_{1} \cdot x * CopySign ( {v}_{1} \cdot y )$$

$$Else :$$

$${v}_{2} \cdot x = {v}_{1} \cdot x$$

$${v}_{2} \cdot y = {v}_{1} \cdot y$$

With the CopySign(x) function returning the sign of x (e.g., +1 for positive x and −1 for negative x). Then 12 is scaled to unsigned 2D vector of bitdepth qpOcta.

$${v}_{out} = \frac{( {v}_{2} - min )}{max - min} * ( {2}^{qpOcta} - 1 )$$

$${v}_{out} = \frac{( {v}_{2} + 1 )}{2} * ( {2}^{qpOcta} - 1 )$$

Where min and max are the minimum and maximum value of the 3D vector v₂ which should be −1 and 1 respectively.

The above equations are still floating-point representation and are converted to a fixed-point integer representation which is mathematically formulated as:

The recipApprox(x,s) function is employed as an s-bit fixed-point approximation of the reciprocal of x. This function is explained in detail in the mathematic functions section.

So, the equation becomes:

$${v}_{0} = {v}_{in} - ( 1 ≪ ( qn - 1 ) )$$

$${v}_{1} = {v}_{0} * recipApprox ( ( abs ( {v}_{0} \cdot x ) + abs ( {v}_{0} \cdot y ) + abs ( {v}_{0} \cdot z ) ) , s )$$

$$If {v}_{1} \cdot z is negative , then :$$

$${v}_{2} \cdot x = ( 1 ≪ s ) - {v}_{1} \cdot y * CopySign ( {v}_{1} \cdot x )$$

$${v}_{2} \cdot y = ( 1 ≪ s ) - {v}_{1} \cdot x * CopySign ( {v}_{1} \cdot y )$$

$$Else :$$

$${v}_{2} \cdot x = {v}_{1} \cdot x$$

$${v}_{2} \cdot y = {v}_{1} \cdot y$$

Then v₂ is scaled to unsigned 2D vector of bitdepth qpOcta.

$${v}_{out} = ( ( {v}_{2} + ( 1 ≪ s ) ) ≫ 1 ) * ( {2}^{qpOcta} - 1 ) \div {2}^{s}$$

$${v}_{out} = ( ( ( {v}_{2} + ( 1 ≪ s ) ) ≪ ( qpOca - 1 ) ) - ( ( {v}_{2} + ( 1 ≪ s ) ) ≫ 1 ) ) ≫ s$$

Adding rounding to the above equation gives us the final output:

$${v}_{out} = ( ( ( {v}_{2} + ( 1 ≪ s ) ) ≪ ( qpOcta - 1 ) ) - ( ( {v}_{2} + ( 1 ≪ s ) + 1 ) ≫ 1 ) + ( 1 ≪ ( s - 1 ) ) ) ≫ s$$

The above equations are the ones implemented in Table 5 and convert 3D to 2D octahedral sections above.

V-DMC encoder 200 and V-DMC decoder 300 may be configured to perform 2D-to-3D conversion. The input is an unsigned 2D vector vᵢₙ with bitdepth qpOcta and the output is a normalized and scaled unsigned 3D vector vₒᵤₜ with bitdepth qn.

The following are the mathematical equations for this function.

$${v}_{1} = ( ( \frac{{v}_{in}}{{2}^{qpOcta} - 1} ) * ( max - min ) ) + min$$

Where min and max are the minimum and maximum value of the

$$( \frac{{v}_{in}}{{2}^{qpOcta} - 1} )$$

vector which is −1 and 1 respectively.

$${v}_{2} \cdot x = {v}_{1} \cdot x$$

$${v}_{2} \cdot y = {v}_{1} \cdot y$$

$${v}_{2} \cdot z = 1 - abs ( {v}_{1} \cdot x ) - abs ( {v}_{1} \cdot y )$$

If v₂·z is negative, then:

$$t = {v}_{2} \cdot x$$

$${v}_{2} \cdot x = 1 - abs ( {v}_{2} \cdot y ) * CopySign ( t )$$

$${v}_{2} \cdot y = 1 - abs ( t ) * CopySign ( {v}_{2} \cdot y )$$

Then v₂ is scaled to unsigned 3D vector of bitdepth qn.

$${v}_{out} = \frac{( normalize ( {v}_{2} ) - min )}{max - min} * ( {2}^{qn} - 1 )$$

Where min and max are the minimum and maximum value of the normalize(vᵢₙ) 3D vector which is −1 and 1 respectively. This makes the equation:

$${v}_{out} = \frac{( normalize ( {v}_{2} ) + 1 )}{2} * ( {2}^{qn} - 1 )$$

$$where$$

$$normalize ( {v}_{2} ) = N = \frac{{v}_{2}}{sqrt ( ( {v}_{2} \cdot x * {v}_{2} \cdot x ) + ( {v}_{2} \cdot y * {v}_{2} \cdot y ) + ( {v}_{2} \cdot z * {v}_{2} \cdot z ) )}$$

The above equations are still floating-point representation and are converted to a fixed-point integer representation which is mathematically formulated as:

To convert this into a fixed-point integer representation, the IntRecipSqrt(x) implementation is used that is explained in detail in the mathematical functions section. The function IntRecipSqrt(x) is a 40-bit fixed-point approximation of the reciprocal square root of x. Let s=40, so the equations above becomes:

$${v}_{1} = {v}_{in} * 2 - ( {2}^{qpOcta} - 1 )$$

$${v}_{1} = ( {v}_{in} ≪ 1 ) - ( {2}^{qpOcta} - 1 )$$

$${v}_{2} \cdot x = {v}_{1} \cdot x$$

$${v}_{2} \cdot y = {v}_{1} \cdot y$$

$${v}_{2} \cdot z = ( 1 ≪ qpOcta ) - 1 - abs ( {v}_{1} \cdot x ) - abs ( {v}_{1} \cdot y )$$

If v₂·z is negative, then:

$$t = {v}_{2} \cdot x$$

$${v}_{2} \cdot x = ( 1 ≪ qpOcta ) - 1 - abs ( {v}_{2} \cdot y ) * CopySign ( {v}_{2} \cdot x )$$

$${v}_{2} \cdot y = ( 1 ≪ qpOcta ) - 1 - abs ( t ) * CopySign ( {v}_{2} \cdot y )$$

$${v}_{out} = \frac{( {v}_{2} * IntRecipSqrt ( Dot ( {v}_{2} , {v}_{2} ) ) + 1 * {2}^{s} )}{2} * ( {2}^{qn} - 1 ) \div {2}^{s}$$

Let N=v₂*IntRecipSqrt (Dot (v₂, v₂)). Equation can be simplified to the following in fixed-point integer implementation:

$${v}_{out} = ( ( N + ( 1 ≪ s ) ) ≫ 1 ) * ( {2}^{qn} - 1 ) \div {2}^{s}$$

$${v}_{out} = ( ( ( N + ( 1 ≪ s ) ) ≪ ( qn - 1 ) ) - ( ( N + ( 1 ≪ s ) ) ≫ 1 ) ) ≫ s$$

Adding rounding to the above equation gives us the final output:

$${v}_{out} = ( ( ( N + ( 1 ≪ s ) ) ≪ ( qn - 1 ) ) - ( ( N + ( 1 ≪ s ) + 1 ) ≫ 1 ) + ( 1 ≪ ( s - 1 ) ) ) ≫ s$$

The above equations are the ones implemented in Table 6 and the convert 2D octahedral to 3D section.

### Code

TABLE 1
Normal Prediction Function.

```
  void NormalVertexAttributeDecoder::decodeWithPrediction(
    int c,
    const std::vector<int>& attrIndices
  ) {
    const auto MAX_PARALLELOGRAMS = 4;
    auto& ov = mainDec−>attr−>ct;
```

| | |
|---|---|
| const auto& O = ov.O; | // pO |
| const auto& V = ov.V; | // pV |
| const auto& OAI = attr−>ct.O; | // auxO |
| auto& AV = attr−>values; | // auxNorm |
| const auto& AI = attrIndices; | // auxV |
| const auto& ai = AI[c]; | // v |
| auto& MV = mainDec−>MV; | // mV |

```
    // is vertex already predicted ?
    if (MV[ai] > 0)
      return;
    // we mark the vertex
    MV[ai] = 1;
    // search for some estimations around the vertex of the corner
    // the triangle fan might not be complete since we do not use dummy points,
    // but we know that a vertex is not non-manifold, so we have only one fan per
vertex
    // also some opposite might not be defined due to boundaries
    int altC = c;
    // loop through corners attached to the current vertex
    // swing around the fan until we find a border
    bool onSeam = (OAI.size( ) != 0 ? (OAI[ov.n(altC)] == −2) : false);
    int nextC = ov.n(O[ov.n(altC)]);
    while (nextC >= 0 && nextC != c && !onSeam)
    {
      altC = nextC;
      onSeam = (OAI.size( ) != 0 ? (OAI[ov.n(altC)] == −2) : false);
      nextC = ov.n(O[ov.n(altC)]);
    };
    bool isBoundary = (!onSeam && nextC != c);
    // now we are position on the right most corner sharing v
    // we turn left an evaluate the possible predictions
    int startC = altC;
```

| | |
|---|---|
| int count = 0; | // number of valid stretch found |
| glm::vec3 predNorm(0, 0, 0); | // the predicted norm |

```
    if (attr−>predMethod == (int8_t)EBConfig::NormPred::MPARA) {
      do
      {
        if (count >= MAX_PARALLELOGRAMS) break;
        const auto oppoV = (O[altC]>=0) ? AI[O[altC]] : −1;
        const auto prevV = AI[ov.p(altC)];
        const auto nextV = AI[ov.n(altC)];
        if ((oppoV > −1 && prevV > −1 && nextV > −1) &&
          ((MV[oppoV] > 0) && (MV[prevV] > 0) && (MV[nextV] > 0)))
        {
    else if (attr−>predMethod == (int8_t)EBConfig::NormPred::CROSS) {
      do
      {
        const auto prevV = AI[ov.p(altC)];
        const auto nextV = AI[ov.n(altC)];
        if (prevV > −1 && nextV > −1) // no check on marked predictions as Geo
only used
        {
          predictNormCross(altC, predNorm);
          ++count;
        }
        onSeam = (OAI.size( ) != 0 ? (OAI[ov.p(altC)] == −3) : false);
```

| | |
|---|---|
| altC = ov.p(O[ov.p(altC)]); | // swing around the triangle fan |
| } while (altC >= 0 && altC != startC && !onSeam); | // incomplete fan or |

```
full rotation
    }
    // 1. use MPARA or Cross
    if (count > 0 && !(predNorm == glm::vec3(0,0,0))) {
      const glm::i64vec3 predNormI64 = predNorm;
      int64_t dot_predNorm = predNormI64.x * predNormI64.x +
predNormI64.y * predNormI64.y + predNormI64.z * predNormI64.z;
      const int64_t irsqt = irsqrt(dot_predNorm);
      const glm::i64vec3 st1 = predNormI64 * irsqt;
      const glm::i64vec3 st2 = st1 + (int64_t)(1ULL << NRM_SHIFT_1);
      const glm::i64vec3 st3 = st2 << (int64_t)(qn−1);
      const glm::i64vec3 st4 = ((st2 + (int64_t)1) >> (int64_t)(1));
      const glm::i64vec3 st5 = st3 − st4 + (int64_t)(1ULL << (NRM_SHIFT_1−
1));
      const glm::vec3 scaledPredNorm = st5 >> NRM_SHIFT_1;
      if (useOctahedral)
        decodeOctahedral(scaledPredNorm, AV[ai], 1);
      else
        AV[ai] = scaledPredNorm + readNrmDeltaFine( );
      return;
    }
    // 2. or fallback to delta with available values
    const auto& c_p_ai = AI[ov.p(c)];
    const auto& c_n_ai = AI[ov.n(c)];
    if (c_p_ai > −1 && MV[c_p_ai] > −1) {
      if (useOctahedral)
        decodeOctahedral(AV[c_p_ai], AV[ai], 0);
      else
        AV[ai] = readNrmDeltaCoarse( ) + AV[c_p_ai];
      return;
    }
    if (c_n_ai > −1 && MV[c_n_ai] > −1) {
      if (useOctahedral)
        decodeOctahedral(AV[c_n_ai], AV[ai], 0);
      else
        AV[ai] = readNrmDeltaCoarse( ) + AV[c_n_ai];
      return;
    }
    // 3. or maybe we are on a boundary
    // then we may use deltas from previous vertex on the boundary
    if (isBoundary) {
      const auto b = ov.p(startC); // b is on boundary
      const auto b_ai = AI[b];
      if (MV[b_ai] > −1) {
        if (useOctahedral)
          decodeOctahedral(AV[b_ai], AV[ai], 0);
        else
          AV[ai] = readNrmDeltaCoarse( ) + AV[b_ai];
        return;
      }
    }
    // 4. no more choices, it is a start
    AV[ai] = readNrmStart( );
    return;
```

TABLE 2
Normal Prediction Scheme using MPARA

```
void NormalVertexAttributeDecoder::predictNormPara(
  const int c, const std::vector<int>& attrIndices,
  glm::vec3& predNorm
) {
  auto& ov = mainDec−>attr−>ct;
  const auto& O = ov.O;
  auto& AV = attr−>values;
  const auto& AI = attrIndices; // texture coordinates indices
  glm::vec3 avOppo = AV[AI[O[c]]]; // recheck vs auxO
  glm::vec3 avPrev = AV[AI[ov.p(c)]];
  glm::vec3 avNext = AV[AI[ov.n(c)]];
  // parallelogram prediction estNorm = prevNrm + nextNrm − oppoNrm
  glm::i32vec3 estNorm = avPrev + avNext − avOppo;
  const int32_t center = (1u << static_cast<uint32_t>(qn − 1));
  for (int c = 0; c < 3; c++) {
    estNorm[c] = estNorm[c] − center;
  }
  predNorm += estNorm;
}
```

TABLE 3
Normal Prediction Scheme using CROSS Product

```
void NormalVertexAttributeDecoder::predictNormCross(
  const int c, glm::vec3& predNorm
) {
  auto& ov = mainDec−>attr−>ct;
  const auto& G = mainDec−>attr−>values;
  const auto& V = ov.V;
  glm::i64vec3 gPrev = G[V[ov.p(c)]];
  glm::i64vec3 gNext = G[V[ov.n(c)]];
  glm::i64vec3 gCurr = G[V[c]];
  const glm::i64vec3 gCgP = gPrev − gCurr;
  const glm::i64vec3 gCgN = gNext − gCurr;
  glm::vec3 estNorm;
  estNorm[0] = gCgN.y * gCgP.z − gCgP.y * gCgN.z;
    estNorm[1] = gCgN.z * gCgP.x − gCgP.z * gCgN.x;
    estNorm[2] = gCgN.x * gCgP.y − gCgP.x * gCgN.y;
  predNorm += estNorm;
}
```

TABLE 4
Decode Octahedral Function

```
  void NormalVertexAttributeDecoder::decodeOctahedral(const glm::vec3 pred,
glm::vec3& rec, const bool fine) {
    glm::vec2 first2Dresidual(0, 0);
    if (fine)
      first2Dresidual = readNrmOctaFine( );
    else
      first2Dresidual = readNrmOctaCoarse( );
    glm::vec2 pred2D(0, 0);
    convert3Dto2Doctahedral(pred, pred2D);
    glm::vec2 orig2D = pred2D + first2Dresidual;
    glm::vec3 reconstructed3D(0, 0, 0);
    convert2DoctahedralTo3D(orig2D, reconstructed3D);
    if (normalEncodeSecondResidual)
      rec = reconstructed3D + readOctsecondResiduals( );
    else
      rec = reconstructed3D;
    return;
  }
```

TABLE 5
Function to Convert 3D Unit Vector to 2D Octahedral.

```
  void NormalVertexAttributeDecoder::convert3Dto2Doctahedral(glm::vec3
input, glm::vec2& output) {
    // Center
    const int32_t center = ( 1u << static_cast<uint32_t>( qn−1 ));
    for (int c = 0; c < 3; c++) {
      input[c] = input[c] − center;
    }
    const uint64_t divisor = std::abs(input.x) + std::abs(input.y) +
std::abs(input.z);
    int32_t shift;
    const int64_t recipD = recipApprox(divisor, shift); // fxp:shift
    glm::i64vec3 st0 = input;
    glm::i64vec3 normalized = st0 * recipD;
    glm::i64vec2 octahedral;
    if (normalized.z >= 0) {
      octahedral.x = normalized.x;
      octahedral.y = normalized.y;
    } else {
      octahedral.x = ((1ULL<<shift) − std::abs(normalized.y)) * std::copysign(1.f,
normalized.x);
      octahedral.y = ((1ULL<<shift) − std::abs(normalized.x)) * std::copysign(1.f,
normalized.y);
    }
    // Scale signed to unsigned with proper qp values.
    const glm::i64vec2 step1 = (octahedral + (int64_t)(1ULL << shift)); //
fxp:shift
    const glm::i64vec2 step2 = step1 << (int64_t)(qpOcta−1);
    const glm::i64vec2 step3 = (step1 + (int64_t)1) >> (int64_t)1;
    const glm::i64vec2 step4 = step2 − step3 + (int64_t)(1ULL << (shift−1));
    output = step4 >> (int64_t)shift;
    return;
  }
```

TABLE 6
Convert 2D Octahedral to 3D Unit Vector

```
  void NormalVertexAttributeDecoder::convert2DoctahedralTo3D(glm::vec2
input, glm::vec3& output) {
    #if FXP_NRM
    const glm::i64vec2 inputI64 = input;
    const glm::i64vec2 inputI64_centered = (inputI64<<(int64_t)1) −
(int64_t)((1<<qpOcta)−1);
    glm::i64vec3 threeDvec;
    threeDvec.x = inputI64_centered.x;
    threeDvec.y = inputI64_centered.y;
    threeDvec.z = (1<<qpOcta) − 1 − std::abs(threeDvec.x) −
std::abs(threeDvec.y);
    if (threeDvec.z < 0) {
      const float x_t = threeDvec.x;
      threeDvec.x = (((1<<qpOcta)−1) − std::abs(threeDvec.y)) *
std::copysign(1.f, x_t);
      threeDvec.y = (((1<<qpOcta)−1) − std::abs(x_t)) * std::copysign(1.f,
threeDvec.y);
    }
    int64_t dot_2DI = threeDvec.x * threeDvec.x + threeDvec.y * threeDvec.y +
threeDvec.z * threeDvec.z;
    const int64_t irsqt = irsqrt(dot_2DI); // fxp:40
= NRM_SHIFT_1
    const glm::i64vec3 st1 = threeDvec * irsqt + (int64_t)(1ULL <<
NRM_SHIFT_1);
    const glm::i64vec3 st2 = (st1 << (int64_t)(qn−1)) − ((st1+(int64_t)1) >>
(int64_t)(1));
    output = (st2 + (int64_t)(1ULL << (NRM_SHIFT_1−1))) >> NRM_SHIFT_1;
// fxp:0
    return;
  }
```

The V-DMC decoding process will now be described. The description below shows the sections of the specification that are changed according to this disclosure in the CD document of V-DMC.

TABLE 7
Mesh attribute prediction methods for
MESH_ATTR_NORMAL type attributes

| mesh_attribute_{—} | | |
|---|---|---|
| prediction_{—} | | Prediction |
| method[i] | Identifier | Method |
| 0 | MESH_NORMAL_DELTA | Delta Coding |
| 1 | MESH_NORMAL_MPARA | Multiple |
| | | parallelograms |
| 2 | MESH_NORMAL_CROSS | Cross product |
| >2 | MESH_NORMAL_RESERVED | Reserved |

### Mathematical Functions

```
Cross( x, y ) cross product function, operating on two vectors x and y
Cross( x, y ) {
  v[0] = x[ 1 ] * y[ 2 ] − x[ 2 ] * y[ 1 ]
  v[1] = x[ 2 ] * y[ 0 ] − x[ 0 ] * y[ 2 ]
  v[2] = x[ 0 ] * y[ 1 ] − x[ 1 ] * y[ 0 ]
  return v
}
Dot( vec0, vec1 ) {
  out = 0
  for( d = 0; d < 3; d++ ) {
      out = out + vec0[d] * vec1[d]
  }
  return out
}
CopySign( mag, sgn ) {
  return (sgn >=0 ) ? +mag : −mag
}
isqrt( x ) {
  if (x <= (1 << 46))
      return 1 + ((x * irsqrt(x)) >> 40)
  else {
      x0 = (x + 65536) >> 16;
      return 1 + ((x0 * irsqrt(x0)) >> 32)
}
irsqrt(a64) {
  if (!a64)
      return 0
  shift = −3
  while (a64 & 0xffffffff00000000) {
      a64 >>= 2
      shift−−
  }
  a = a64
  while (!(a & 0xc0000000)) {
      a <<= 2
      shift++
  }
  idx = (a >> 25) − 32
  r = k3timesR[idx] − ((kRcubed[idx] * a) >> 32)
  ar = (r * a) >> 32
  s = 0x30000000 − ((r * ar) >> 32)
  r = (r * s) >> 32
  if (shift > 0)
      return r << shift
  else
      return r >> − shift
}
k3timesR[96] = {
  3196059648, 3145728000, 3107979264, 3057647616, 3019898880, 2969567232,
  2931818496, 2894069760, 2868903936, 2831155200, 2793406464, 2768240640,
  2730491904, 2705326080, 2667577344, 2642411520, 2617245696, 2592079872,
  2566914048, 2541748224, 2516582400, 2491416576, 2466250752, 2441084928,
  2428502016, 2403336192, 2378170368, 2365587456, 2340421632, 2327838720,
  2302672896, 2290089984, 2264924160, 2252341248, 2239758336, 2214592512,
  2202009600, 2189426688, 2164260864, 2151677952, 2139095040, 2126512128,
  2113929216, 2101346304, 2088763392, 2076180480, 2051014656, 2038431744,
  2025848832, 2013265920, 2000683008, 2000683008, 1988100096, 1962934272,
  1962934272, 1950351360, 1937768448, 1925185536, 1912602624, 1900019712,
  1900019712, 1887436800, 1874853888, 1862270976, 1849688064, 1849688064,
  1837105152, 1824522240, 1811939328, 1811939328, 1799356416, 1786773504,
  1786773504, 1774190592, 1761607680, 1761607680, 1749024768, 1736441856,
  1736441856, 1723858944, 1723858944, 1711276032, 1698693120, 1698693120,
  1686110208, 1686110208, 1673527296, 1660944384, 1660944384, 1648361472,
  1648361472, 1635778560, 1635778560, 1623195648, 1623195648, 1610612736
}
kRcubed[96] = {
  4195081216, 3999986688, 3857709056, 3673323520, 3538940928, 3364924416,
  3238224896, 3114735616, 3034196992, 2915990528, 2800922624, 2725880832,
  2615890944, 2544223232, 2439185408, 2370818048, 2303728640, 2237913088,
  2173355008, 2110061568, 2048008192, 1987165184, 1927563264, 1869150208,
  1840392192, 1783783424, 1728321536, 1701024768, 1647311872, 1620883456,
  1568898048, 1543306240, 1492993024, 1468236800, 1443762176, 1395656704,
  1372007424, 1348605952, 1302626304, 1280060416, 1257736192, 1235650560,
  1213861888, 1192294400, 1171008512, 1149979648, 1108673536, 1088379904,
  1068352512, 1048567808, 1029031936, 1029036032, 1009729536, 971888640,
  971882496, 953319424, 934993920, 916897792, 899011584, 881389568,
  881392640, 864009216, 846846976, 829900800, 813182976, 813201408,
  796721152, 780459008, 764412928, 764417024, 748601344, 732995584,
  733017088, 717624320, 702468096, 702466048, 687520768, 672786432,
  672787456, 658258944, 658256896, 643947520, 629854208, 629862400,
  615976960, 615952384, 602276864, 588779520, 588804096, 575512576,
  575526912, 562433024, 562439168, 549556224, 549564416, 536876032
}
recipApprox( b , log2Scale){
  NIter = 3
  log2ScaleOffset = 0
  log2bPlusOne = IntLog2( b ) + 1
  if ( log2bPlusOne > 31 ) {
    b = b >> ( log2bPlusOne − 31 )
    log2ScaleOffset −= log2bPlusOne − 31
  }
  if (log2bPlusOne < 31) {
      b = b << ( 31 − log2bPlusOne )
      log2ScaleOffset += 31 − log2bPlusOne
  }
  // Initial approximation: 48/17 − 32/17 * b with 28 bits decimal prec
  bRecip = ( ( 0x2d2d2d2d << 31 ) − 0x1e1e1e1e * b ) >> 28;
  for (unsigned i = 0; i < NIter; ++i)
      bRecip += bRecip * ( ( 1 << 31 ) − ( b * bRecip >> 31 ) ) >> 31
  log2Scale = ( 31 << 1 ) − log2ScaleOffset
  return bRecip
  IntLog2( x ) {
      x = ceilpow2(x + 1) − 1
      return popcnt(x) − 1
  }
  popcnt( x ) {
    x = x − ( ( x >> 1 ) & 0x55555555u )
    x = ( x & 0x33333333u ) + ( ( x >> 2 ) & 0x33333333u )
    return ( ( x + ( x >> 4 ) & 0xF0F0F0Fu ) * 0x1010101u ) >> 24
  }
  ceilpow2( x ) {
      x−−
      x = x | ( x >> 1 )
      x = x | ( x >> 2 )
      x = x | ( x >> 4 )
      x = x | ( x >> 8 )
      x = x | ( x >> 16 )
      return x + 1
  }
}
```

V-DMC encoder 200 and V-DMC decoder 300 may be configured to perform prediction of per-vertex normal vector attributes. When mesh_attribute_type equals to MESH_ATTR_NORMAL, the parameter mesh_attribute_prediction_method[index] specifies which normal prediction scheme to use which is defined in Table 1-8. When it is MESH_NORMAL_DELTA, the delta prediction scheme is employed. When it is MESH_NORMAL_MPARA, the multiple parallelogram prediction scheme for normals is employed. When it is MESH_NORMAL_CROSS, the cross-product prediction scheme is employed.

Inputs to this process include:
a variable attrIndex, specifying the index of the attribute on which to perform predictions.
a variable c specifying the index of the corner for which vertex normal will be predicted.
a 1D array auxV, of size CornerCnt, specifying the connectivity to be used to dereference Norm coordinates. aux V refers to a 1D array of the variable AuxiliaryCornerToVertexArray[attrIndex].

Output of this process is indirect:
It modifies the array VertexMarkingArray, Auxiliary StartIndex[attrIndex] AuxiliaryDeltaIndex[attrIndex] and AuxiliaryDeltaCoarseIndexArray[attrIndex] defined in clause I.9.2 in the CD document and the array AttrValues[attrIndex] defined in clause I.9.1 in the CD document.

Let the variable hasOwnIndices, specifying if the auxiliary attribute uses an auxiliary index table, be set to the value of mesh_attribute_separate_index_flag[attrIndex]

Let the alias mV refer to the variable VertexMarkingArray.

Let the alias pO refer to the variable OppositeCornersArray.

Let the alias pV refer to the variable CornerToVertexArray.

Let the alias auxO refer to the variable AuxiliaryOppositeCornersArray[attrIndex].

Let the alias auxNorm refer to the variable AttrValues[attrIndex].

Let the alias auxStartIndex refer to the variable AuxiliaryStartIndex[attrIndex].

Let the alias auxDeltaIndex refer to the variable AuxiliaryDeltaIndexArray[attrIndex].

Let the alias auxDeltaCoarseIndex refer to the variable AuxiliaryDeltaCoarseIndexArray[attrIndex].

Let predictNormPara(c, aux V, predNorm) denote the invocation of the process described in subclause 4.2.3 when mesh_attribute_prediction_method[attrIndex] is equal to MESH_NORMAL_MPARA, with the parameters c, attrIndices as input and variable predNorm as output.

Let predictNormCross(c, aux V, predNorm) denote the invocation of the process described in subclause 4.2.4 when mesh_attribute_prediction_method[attrIndex] is equal to MESH_NORMAL_CROSS, with the parameters c, attrIndices as input and variable predNorm as output.

Let decodeOctahedral(attrIndex, prediction, residual, reconstructed) denote the invocation of the process defined in subclause 4.2.5.

Let the variable maxParallelograms, specifying the maximum number of parallelogram predictions, be initialized as follows:
maxParallelograms=4

Let the variable v, specifying the index of the vertex associated with c, be initialized as follows:

$$v = auxV [ c ]$$

If mV[v] is strictly greater than 0, the vertex v is already predicted, then the process does nothing and returns. Otherwise, the following applies:

// mark the vertex
mV[ v ] = 1

Let the 1D array predNorm, of size 3, specifying the cumulated normal prediction of the vertex associated with c. Let the variable altC and nextC, specify corner indices, and the variable onSeam, specifying if altC is on a seam, be initialized as follows:

```
predNorm[ 0 ] = 0
predNorm[ 1 ] = 0
predNorm[ 2 ] = 0
altC = c
onSeam = ( hasOwnIndices ? ( auxO[ NextCorner( altC ) ] == −2 ) : 0 )
nextC = NextCorner( O[ NextCorner( altC ) ] )
    The following applies:
// loop through corners attached to the current vertex
// swing around the fan until finding a border or a seam
while ( nextC >= 0 && nextC != c && !onSeam ) {
  altC = nextC
  onSeam = ( hasOwnIndices ? ( auxO[NextCorner( altC ) ] == −2 ) : 0 )
  nextC = NextCorner( pO[ NextCorner( altC ) ] )
  }
```

Let the variable isBoundary, specifying if nextC is on a boundary but not on an attribute seam, and the variable count, specifying the number of valid normal predictions found, and the variable startC, specifying the index of the extreme corner of the fan, be initialized as follows:

```
isBoundary = ( !onSeam && nextC != c )
  count = 0
  startC = altC
```

Let the variables prevV, oppoV and nextV, specifying the index of the vertex associated with previous, opposite, and next corners respectively, be set to 0.

Let the alias qn refer to the normal bit depth defined by mesh_attribute_bit_depth_minus1[attrIndex]+1.

Let the variables nrmShift be initialized as follows:

$$nrmShift = 40$$

First predict the normals and sum all the predictions:

```
  /* currently positioned on the right most corner sharing v */
  /* turn left and evaluate the possible predictions */
  if ( mesh_attribute_prediction_method == MESH_NORMAL_MPARA ){
    do {
      if (count >= maxParallelograms) break;
      oppoV = (hasOwnIndices && auxO[ altC ] == −2 ) ?
        −1 : GetVertexIndex( auxV , pO[ altC ] )
      prevV = GetVertexIndex( auxV, PreviousCorner( altC ) )
      nextV = GetVertexIndex( auxV, NextCorner( altC ) )
      if( ( oppoV > −1 && prevV > −1 && nextV > −1 ) &&
        ( ( mV[ oppoV ] > 0 ) && ( mV[ prevV ] > 0 ) && ( mV[ nextV ] > 0 )
) ){
        predictNormPara(altC, auxV, predNorm)
        ++count
      }
      onSeam = ( hasOwnIndices ? ( auxO[ PreviousCorner( altC ) ] == −2 ) : 0 )
      // swing around the triangle fan
      altC = PreviousCorner( pO[ PreviousCorner( altC ) ] )
      // stop on incomplete fan or full rotation
    } while (altC >= 0 && altC != startC && !onSeam)
  }
  if ( mesh_attribute_prediction_method == MESH_NORMAL_CROSS ){
    do {
      prevV = GetVertexIndex( auxV, PreviousCorner( altC ) )
      nextV = GetVertexIndex( auxV, NextCorner( altC ) )
      if( prevV > −1 && nextV > −1 ) {
        predictNormCross( altC, auxV, predNorm)
        ++count
      }
      onSeam = ( hasOwnIndices ? ( auxO[ PreviousCorner( altC) ] == −2 ) : 0 )
      // swing around the triangle fan
      altC = PreviousCorner( pO[ PreviousCorner( altC ) ] )
      // stop on incomplete fan or full rotation
    } while (altC >= 0 && altC != startC && !onSeam)
  }
```

If the normals were successfully predicted using CROSS or MPARA, the prediction is normalized, scaled and stored using either Octahedral or Non-octahedral method:

```
  // 1. use Cross prediction or Multi-parallelogram
  if( count > 0 && ( predNorm[ 0 ] != 0 || predNorm[ 1 ] != 0 || predNorm[ 2 ] != 0 ))
{
    // Normalize and scale the prediction to qn
    dotPredNorm = Dot( predNorm, predNorm )
    irsqt = irsqrt( dotPredNorm )
    step1[ 0 ] = ( predNorm[ 0 ] * irsqt ) + ( 1 << nrmShift )
    step1[ 1 ] = ( predNorm[ 1 ] * irsqt ) + ( 1 << nrmShift )
    step1[ 2 ] = ( predNorm[ 2 ] * irsqt ) + ( 1 << nrmShift )
    step2[ 0 ] = step1[ 0 ] << ( qn − 1 )
    step2[ 1 ] = step1[ 1 ] << ( qn − 1 )
    step2[ 2 ] = step1[ 2 ] << ( qn − 1 )
    step3[ 0 ] = ( step1[ 0 ] + 1 ) >> 1
    step3[ 1 ] = ( step1[ 1 ] + 1 ) >> 1
    step3[ 2 ] = ( step1[ 2 ] + 1 ) >> 1
    normalizedAndScaledPredNorm[ 0 ] = ( step2[ 0 ] − step3[ 0 ] +
          ( 1 << ( nrmShift − 1 ))) >> nrmShift
    normalizedAndScaledPredNorm[ 1 ] = ( step2[ 1 ] − step3[ 1 ] +
          ( 1 << ( nrmShift − 1 ))) >> nrmShift
    normalizedAndScaledPredNorm[ 2 ] = ( step2[ 2 ] − step3[ 2 ] +
          ( 1 << ( nrmShift − 1 ))) >> nrmShift
    if ( mesh_normal_octahedral_flag[ attrIndex ] ) {
      residual = mesh_attribute_residual[ attrIndex ][ auxDeltaIndex ]
      decodeOctahedral( normalizedAndScaledPredNorm, residual, auxNorm[ v
] )
    } else {
      auxNorm[ 0 ] = mesh_attribute_residual[ attrIndex ][ auxDeltaIndex ][ 0 ]
        + normalizedAndScaledPredNorm[ 0 ]
      auxNorm[ 1 ] = mesh_attribute_residual[ attrIndex ][ auxDeltaIndex ][ 1 ]
        + normalizedAndScaledPredNorm[ 1 ]
      auxNorm[ 2 ] = mesh_attribute_residual[ attrIndex ][ auxDeltaIndex ][ 2 ]
        + normalizedAndScaledPredNorm[ 2 ]
    }
    auxDeltaIndex = auxDeltaIndex + 1
    return
  }
```

If the CROSS or MPARA predictions were unsuccessful, the DELTA prediction is applied:

```
// 2. Fallback to delta with available values
prevV = GetVertexIndex( auxV , PreviousCorner( c ) )
nextV = GetVertexIndex( auxV , NextCorner( c ) )
if( prevV > −1 && mV[ prevV ] > −1 ) {
  if( mesh_normal_octahedral_flag[ attrIndex ] ) {
    prediction = auxNorm[ prevV ]
residual = mesh_attribute_coarse_residual[ attrIndex ][ auxDeltaCoarseIndex ]
    decodeOctahedral( attrIndex, prediction, residual, auxNorm[ v ] )
  } else {
    auxNorm[ v ][ 0 ] =
mesh_attribute_coarse_residual[ attrIndex ][ auxDeltaCoarseIndex ][ 0 ]
      + auxNorm[ prevV ][ 0 ]
    auxNorm[ v ][ 1 ] =
mesh_attribute_coarse_residual[ attrIndex ][ auxDeltaCoarseIndex ][ 1 ]
      + auxNorm[ prevV ][ 1 ]
    auxNorm[ v ][ 2 ] =
mesh_attribute_coarse_residual[ attrIndex ][ auxDeltaCoarseIndex ][ 2 ]
      + auxNorm[ prevV ][ 2 ]
  }
  auxDeltaCoarseIndex = auxDeltaCoarseIndex + 1
  return
}
if( nextV > −1 && MV[ nextV ] > −1 ) {
  if ( mesh_normal_octahedral_flag[ attrIndex ] ) {
    prediction = auxNorm[ nextV ]
residual = mesh_attribute_coarse_residual[ attrIndex ][ auxDeltaCoarseIndex ]
    decodeOctahedral( attrIndex, prediction, residual, auxNorm[ v ] )
  } else {
    auxNorm[ v ][ 0 ] =
mesh_attribute_coarse_residual[ attrIndex ][ auxDeltaCoarseIndex ][ 0 ]
      + auxNorm[ nextV ][ 0 ]
    auxNorm[ v ][ 1 ] =
mesh_attribute_coarse_residual[ attrIndex ][ auxDeltaCoarseIndex ][ 1 ]
      + auxNorm[ nextV ][ 1 ]
    auxNorm[ v ][ 2 ] =
mesh_attribute_coarse_residual[ attrIndex ][ auxDeltaCoarseIndex ][ 2 ]
      + auxNorm[ nextV ][ 2 ]
  }
  auxDeltaCoarseIndex = auxDeltaCoarseIndex + 1
  return
}
```

Let the variable b, specifying the index of the previous corner on the boundary. Let the variable bV, specifying the index of the vertex associated with b.

```
  // 3. If on a boundary
  // then use delta from previous vertex on the boundary
  if( isBoundary ) {
    b = PreviousCorner( startC )
    bV = GetVertexIndex( pV, b )
    if ( mV[ bV ] > −1 ) {
      if ( mesh_normal_octahedral_flag[ attrIndex ] ) {
        prediction = auxNorm[ bV ]
        residual =
          mesh_attribute_coarse_residual[ attrIndex ][ auxDeltaCoarseIndex
]
        decodeOctahedral( attrIndex, prediction, residual, auxNorm[ v ] )
      } else {
        auxNorm[ v ][ 0 ] =
          mesh_attribute_coarse_residual[ attrIndex ][ auxDeltaCoarseIndex
][ 0 ]
          + auxNorm[ bV ][ 0 ]
        auxNorm[ v ][ 1 ] =
          mesh_attribute_coarse_residual[ attrIndex ][ auxDeltaCoarseIndex
][ 0 ]
          + auxNorm[ bV ][ 1 ]
        auxNorm[v][2] =
          mesh_attribute_coarse_residual[ attrIndex ][ auxDeltaCoarseIndex
][ 2 ]
          + auxNorm[ bV ][ 2 ]
      }
      auxDeltaCoarseIndex = auxDeltaCoarseIndex + 1
      return
    }
  }
```

If all the predictions fail, the absolute value of the normal is stored.

```
  // 4. If no more choices, then use an absolute value (i.e. a start)
auxNorm[ v ][ 0 ] = mesh_attribute_start[ attrIndex ][
auxStartIndex ][ 0 ]
auxNorm[ v ][ 1 ] = mesh_attribute_start[ attrIndex ][
auxStartIndex ][ 1 ]
auxNorm[ v ][ 2 ] = mesh_attribute_start[ attrIndex ][
auxStartIndex ][ 2 ]
  auxStartIndex = auxStartIndex + 1
```

V-DMC encoder 200 and V-DMC decoder 300 may be configured to perform MPARA prediction of normals. Inputs to this process include:
a variable altC specifying the index of the corner for which vertex position will be predicted.
a 1D array auxV, of size CornerCnt, specifying the connectivity to be used to dereference Norm coordinates. auxV refers to a 1D array of the variable AuxiliaryCornerToVertexArray[attrIndex].

Output of this process is indirect:
It modifies the array predNorm that is the predicted normal value

Let the alias pO refer to the variable OppositeCornersArray.

Let the alias auxNorm refer to the variable AttrValues[attrIndex].

Let center be a three-dimensional point defining the middle point (center point) of the normal 3D representation defined as:

```
center[ 0 ] = 1 << ( qn − 1 )
  center[ 1 ] = 1 << ( qn − 1 )
  center[ 2 ] = 1 << ( qn − 1 )
```

The prediction follows the following decoding process:

```
oppoV = GetVertexIndex( auxV , pO[ altC ] )
  prevV = GetVertexIndex( auxV , PreviousCorner( altC ) )
  nextV = GetVertexIndex( auxV , NextCorner( altC ) )
  estNorm[ 0 ] = auxNorm[ prevV ][ 0 ] + auxNorm[ nextV ][ 0 ]
    − auxNorm[ oppoV ][ 0 ]
  estNorm[ 1 ] = auxNorm[ prevV ][ 1 ] + auxNorm[ nextV ][ 1 ]
    − auxNorm[ oppoV ][ 1 ]
  estNorm[ 2 ] = auxNorm[ prevV ][ 2 ] + auxNorm[ nextV ][ 2 ]
    − auxNorm[ oppoV ][ 2 ]
estNorm[ 0 ] = estNorm[ 0 ] − center[ 0 ]
estNorm[ 1 ] = estNorm[ 1 ] − center[ 1 ]
estNorm[ 2 ] = estNorm[ 2 ] − center[ 2 ]
predNorm[ 0 ] = predNorm[ 0 ] + estNorm[ 0 ]
predNorm[ 1 ] = predNorm[ 1 ] + estNorm[ 1 ]
predNorm[ 2 ] = predNorm[ 2 ] + estNorm[ 2 ]
```

V-DMC encoder 200 and V-DMC decoder 300 may be configured to perform cross-product prediction of normal. Inputs to this process include:
a variable altC specifying the index of the corner for which vertex position will be predicted.
a 1D array aux V, of size CornerCnt, specifying the connectivity to be used to dereference Norm coordinates. auxV refers to a 1D array of the variable AuxiliaryCornerToVertexArray[attrIndex].

Output of this process is indirect:
It modifies the array predNorm that is the predicted normal value.

Let the alias pG refer to the variable VertCoordValues.

v = GetVertexIndex( CornerToVertexArray, altC )
prevV = GetVertexIndex( pV , PreviousCorner( altC ) )
nextV = GetVertexIndex( pV , NextCorner( altC ) )
vCP[0] = pG[ prevV ][ 0 ] − pG[ v ][ 0 ]
vCP[1] = pG[ prevV ][ 1 ] − pG[ v ][ 1 ]
vCP[2] = pG[ prevV ][ 2 ] − pG[ v ][ 2 ]
vCN[0] = pG[ nextV ][ 0 ] − pG[ v ][ 0 ]
vCN[1] = pG[ nextV ][ 1 ] − pG[ v ][ 1 ]
vCN[2] = pG[ nextV ][ 2 ] − pG[ v ][ 2 ]
estNorm = Cross( vCP, vCN )
predNorm[ 0 ] = predNorm[ 0 ] + estNorm[ 0 ]
predNorm[ 1 ] = predNorm[ 1 ] + estNorm[ 1 ]
predNorm[ 2 ] = predNorm[ 2 ] + estNorm[ 2 ]

V-DMC encoder 200 and V-DMC decoder 300 may be configured to decode octahedral normal. Inputs to this process include:
a variable attrIndex, specifying the index of the attribute on which to perform predictions.
a variable prediction, specifying the three-dimensional normal vector that was predicted.
a variable residual, specifying the 2D octahedral representation of the first residual of normal.

Output of this Inputs to this process include:
a variable reconstructed, specifying the three-dimensional normal vector that was reconstructed after addition of first and possibly second residual.

Let the alias secondRes refer to the variable mesh_normal_octahedral_second_residual[attrIndex]

Let the alias second_residual_flag refer to the variable mesh_normal_octahedral_second_residual_flag[attrIndex]

Let the alias normSecondResidualIndex refer to the variable NormalSecondResidualIndexArray defined in subclause I.9.2 in the CD document.

Let convert3Dto2Doctahedral(3Dvector) denote the invocation of the process defined in subclause 4.2.6.

Let convert2DoctahedralTo3D(2Dvector) denote the invocation of the process defined in subclause 4.2.7.

```
pred2D = convert3Dto2Doctahedral( prediction )
rec2D = pred2D + residual
rec3DWithoutSecondResidual = convert2DoctahedralTo3D( rec2D )
if( second_residual_flag ) {
  reconstructed[ 0 ] = rec3DWithoutSecondResidual[ 0 ]
    + secondRes[ attrIndex ][ normSecondResidualIndex ][ 0 ]
  reconstructed[ 1 ] = rec3DWithoutSecondResidual[ 1 ]
    + secondRes[ attrIndex ][ normSecondResidualIndex ][ 1 ]
  reconstructed[ 2 ] = rec3DWithoutSecondResidual[ 2 ]
    + secondRes[ attrIndex ][ normSecondResidualIndex ][ 2 ]
  normSecondResidualIndex = normSecondResidualIndex + 1
} else {
  reconstructed = rec3DWithoutSecondResidual
}
```

V-DMC encoder 200 and V-DMC decoder 300 may be configured to convert 3D to 2D octahedrals. Inputs to this process include:
a variable 3Dvector, specifying the three-dimensional vector in unsigned integer format.

Outputs of this process include:
a variable 2Dvector, specifying the two-dimensional octahedral representation in unsigned integer format.

Let alias qn refer to the normal bit depth defined by mesh_attribute_bit_depth_minus1[attrIndex]+1.

Let alias qpOcta refer to the octahedral normal bit depth defined by mesh_normal_octahedral_bit_depth_minus1[attrIndex]+1

Let the variables shift be initialized as follows:

$$shift = 0$$

Let center be a three-dimensional point defining the middle point (center point) of the normal 3D representation defined as:

$$center [ 0 ] = 1 ≪ ( qn - 1 )$$

$$center [ 1 ] = 1 ≪ ( qn - 1 )$$

$$center [ 2 ] = 1 ≪ ( qn - 1 )$$

The input 3Dvector is first centered to zero and then normalized.

3Dvector[ 0 ] = 3Dvector[ 0 ] − center[ 0 ]
3Dvector[ 1 ] = 3Dvector[ 1 ] − center[ 1 ]
3Dvector[ 2 ] = 3Dvector[ 2 ] − center[ 2 ]
// Normalized
sum = Abs( 3Dvector[ 0 ] ) + Abs( 3Dvector[ 1 ] ) + Abs( 3Dvector[ 2 ] )
recipSum = recipApprox( sum , shift )
3DvectorNormalized[ 0 ] = 3Dvector[ 0 ] * recipSum
3DvectorNormalized[ 1 ] = 3Dvector[ 1 ] * recipSum
3DvectorNormalized[ 2 ] = 3Dvector[ 2 ] * recipSum

Then convert the float 3D vector to a 2D octahedral representation:

```
if ( 3Dvector [ 2 ] >= 0){
  2Dvector[ 0 ] = 3Dvector[ 0 ]
  2Dvector[ 1 ] = 3Dvector[ 1 ]
} else {
  2Dvector[0] = CopySign( ( 1 << shift ) − Abs( 3Dvector[ 1 ] ),
  3Dvector[ 0 ] )
  2Dvector[1] = CopySign( ( 1 << shift ) − Abs( 3Dvector[ 0 ] ),
  3Dvector[ 1 ] )
}
```

Then scale the signed 2D vector to unsigned 2D vector to qpOcta bit depth.

step1[ 0 ] = ( 2Dvector[ 0 ] + ( 1 << shift ) )
step1[ 1 ] = ( 2Dvector[ 1 ] + ( 1 << shift ) )
step1[ 2 ] = ( 2Dvector[ 2 ] + ( 1 << shift ) )
step2[ 0 ] = step1[ 0 ] << ( qpOcta − 1 )
step2[ 1 ] = step1[ 1 ] << ( qpOcta − 1 )
step2[ 2 ] = step1[ 2 ] << ( qpOcta − 1 )
step3[ 0 ] = ( step1[ 0 ] + 1 ) >> 1
step3[ 1 ] = ( step1[ 1 ] + 1 ) >> 1
step3[ 2 ] = ( step1[ 2 ] + 1 ) >> 1
2Dvector[ 0 ] = ( step2[ 0 ] − step3[ 0 ] + ( 1 << ( shift − 1 ) ) ) >> shift
2Dvector[ 1 ] = ( step2[ 1 ] − step3[ 1 ] + ( 1 << ( shift − 1 ) ) ) >> shift
2Dvector[ 2 ] = ( step2[ 2 ] − step3[ 2 ] + ( 1 << ( shift − 1 ) ) ) >> shift

V-DMC encoder 200 and V-DMC decoder 300 may be configured to convert 2D octahedral to 3D. Inputs to this process include:
a variable 2Dvector, specifying the two-dimensional octahedral representation in unsigned integer format.

Output of this Inputs to this process include:
a variable 3Dvector, specifying the three-dimensional vector in unsigned integer format.

Let alias qn refer to the normal bit depth defined by mesh_attribute_bit_depth_minus1[attrIndex]+1.

Let alias qpOcta refer to the octahedral normal bit depth defined by mesh_normal_octahedral_bit_depth_minus1[attrIndex]+1

Let center be an integer defining the middle point (center point) of each axis of the normal 2D representation defined as:

$$center = ( 1 ≪ qpOcta ) - 1$$

The input 2Dvector scaled by two and then centered to zero.

$$2 Dvector [ 0 ] = ( 2 Dvector [ 0 ] ≪ 1 ) - center$$

$$2 Dvector [ 1 ] = ( 2 Dvector [ 1 ] ≪ 1 ) - center$$

Next step involves converting 2D octahedral representation to 3D vector.

```
3Dvector[ 0 ] = 2Dvector[ 0 ]
3Dvector[ 1 ] = 2Dvector[ 1 ]
3Dvector[ 2 ] = ( 1 << qpOcta ) − 1 − Abs( 2Dvector[ 0 ] ) −
Abs( 2Dvector[ 1 ] )
if ( 3Dvector[ 2 ] < 0 ) {
  temporary_x = 3Dvector[ 0 ]
  3Dvector[ 0 ] = CopySign( ( 1 << qpOcta ) − 1 −
  Abs( 3Dvector[ 1 ] ),
    temporary_x )
  3Dvector[ 1 ] = CopySign( ( 1 << qpOcta ) − 1 −
    Abs( temporary_x ) ), 3Dvector[ 1 ] )
}
```

Then the 3D vector is normalized, scaled and quantized to qn value.

// Normalize and scale the normals to qn
dot3Dvector = Dot( 3Dvector, 3Dvector)
irsqt = irsqrt( dot3Dvector)
step1[ 0 ] = ( 3Dvector[ 0 ] * irsqt ) + ( 1 << nrmShift)
step1[ 1 ] = ( 3Dvector[ 1 ] * irsqt ) + ( 1 << nrmShift)
step1[ 2 ] = ( 3Dvector[ 2 ] * irsqt ) + ( 1 << nrmShift)
step2[ 0 ] = step1[ 0 ] << ( qn − 1 )
step2[ 1 ] = step1[ 1 ] << ( qn − 1 )
step2[ 2 ] = step1[ 2 ] << ( qn − 1 )
step3[ 0 ] = ( step1[0] + 1 ) >> 1
step3[ 1 ] = ( step1[1] + 1 ) >> 1
step3[ 2 ] = ( step1[2] + 1 ) >> 1
3Dvector[ 0 ] = ( step2[ 0 ] − step3[ 0 ] + ( 1 <<
( nrmShift − 1 ))) >> nrmShift
3Dvector[ 1 ] = ( step2[ 1 ] − step3[ 1 ] + ( 1 <<
( nrmShift − 1 ))) >> nrmShift
3Dvector[ 2 ] = ( step2[ 2 ] − step3[ 2 ] + ( 1 <<
( nrmShift − 1 ))) >> nrmShift

V-DMC encoder 200 and V-DMC decoder 300 may be configured to perform wrap around. The '219 application previously introduced the possibility of adding “wrap around” and “rotation and inversion” in the octahedral representation.

Wrap around. The current implementation of octahedral encoding subtracts the 2D octahedral prediction from the original 2D octahedral normal to get the residual. However, if the prediction and the original normal are on the boundary edge of the sphere as shown in FIG. 13. If in FIG. 13, the prediction and the original normal falls on a boundary and ends up in a different colored square/triangle, then the prediction and the original normal are warped to a much farther distance in the 2D octahedral representation. This increase in distance between the prediction and the original may lead to a higher residual.

To improve the encoding efficiency, wrap around may be introduced for when the distance between the original and prediction in one dimension is greater than half the square's length, we decide to move in the other direction.

The algorithm employs the minimum (MIN) and maximum (MAX) limits of the original normal to wrap the stored residual values around the center point of zero. Specifically, when the range of the original values, denoted as (N), is confined within (<MIN, MAX>) and defined by (N=MAX−MIN), any residual value (R), which is the difference between (N) and a predicted value (P), is stored as follows:

$${R}^{′} = \{ \begin{matrix}R + N & if R < - \frac{N}{2} \\ R - N & if R > \frac{N}{2} \\ R & otherwise\end{matrix}$$

To decode this value, the decoder evaluates whether the final reconstructed value (F=P+R′) exceeds the original dataset's bounds. If (F) is outside these bounds, it is adjusted using:

$$\{ \begin{matrix}F + N , & if F < MIN \\ F - N , & if F > MAX\end{matrix}$$

This process of wrapping effectively reduces the diversity of values, leading to an improved entropy for the stored values and, consequently, more efficient compression ratios.

Rotating the octahedral square. The transformation is applied to normals represented in octahedral coordinates. The process subdivides a square into eight triangles: four form an inner diamond pattern, and four are outer triangles. The inner diamond is associated with the octahedron's upper hemisphere, while the outer triangles correspond to the lower hemisphere as shown in FIG. 13. For a given predicted value (P) and the actual value (N) that requires encoding, the transformation first evaluates whether (P) lies outside the diamond. If (P) is outside, the transformation inverts the outer triangles towards the diamond's interior and vice versa. Subsequently, the transformation checks if (P) resides within the bottom-left quadrant. If (P) is not in this quadrant, it applies a rotation to both (P) and (N) to reposition them. This makes sure that the (P) is always in the bottom-left quadrant. The residual value is then calculated based on the new positions of (P) and (N) post-mapping and rotation. This inversion typically results in more concise residuals, and the rotation ensures that all larger residual values are positive. This positivity reduces the residual values' range, thereby increasing the frequency of large positive residual values, which benefits the entropy encoder's efficiency. This encoding process is possible because the decoder also has knowledge of (P).

If the wrap around is enabled and implemented in the fixed-point integer implementation, the decoding code shown in Table 4 changes to the following (Table 7):

TABLE 7
Updated Decode Octahedral Function with Wrap Around

```
  void NormalVertexAttributeDecoder::decodeOctahedral(const glm::vec3 pred,
glm::vec3& rec, const bool fine) {
    glm::vec2 first2Dresidual(0, 0);
    if (fine)
      first2Dresidual = readNrmOctaFine( );
    else
      first2Dresidual = readNrmOctaCoarse( );
    glm::vec2 pred2D(0, 0);
    convert3Dto2Doctahedral(pred, pred2D);
    glm::vec2 rec2D(0 ,0);
    if (wrapAround) {
      const int32_t center = ( 1u << static_cast<uint32_t>( qpOcta−1 ) );
      for (int c = 0; c < 2; c++) {
        pred2D[c] = pred2D[c] − center;
      }
      rec2D = pred2D + first2Dresidual;
      int32_t maxNormalValueplusOne = ( 1u << static_cast<uint32_t>( qpOcta
) );
      for (int c = 0; c < 2; c++) {
        if (rec2D[c] < −center)
          rec2D[c] = rec2D[c] + maxNormalValueplusOne;
        else if (rec2D[c] > center−1)
          rec2D[c] = rec2D[c] − maxNormalValueplusOne;
      }
      for (int c = 0; c < 2; c++) {
        rec2D[c] = rec2D[c] + center; // Make it back to unsigned integer
      }
    } else {
      rec2D = pred2D + first2Dresidual;
    }
    glm::vec3 reconstructed3D(0, 0, 0);
    convert2DoctahedralTo3D(rec2D, reconstructed3D);
    if (normalEncodeSecondResidual)
      rec = reconstructed3D + readOctsecondResiduals( );
    else
      rec = reconstructed3D;
    return;
  }
```

The encoder side wrap around function may be:

TABLE 8
Encoder side wrap around function

```
  // Encoding
  glm::vec2 orig2D(0, 0);
  glm::vec2 pred2D(0, 0);
  convert3Dto2Doctahedral(original, orig2D);
  convert3Dto2Doctahedral(pred, pred2D);
  glm::vec2 residual2D(0, 0);
  if (wrapAround) {
    const int32_t center = ( 1u << static_cast<uint32_t>( qpOcta−1 ) );
    for (int c = 0; c < 2; c++) {
      orig2D[c] = orig2D[c] − center; // Convert it to signed integer
      pred2D[c] = pred2D[c] − center; // Convert it to signed integer
    }
    residual2D = orig2D − pred2D;
    const int32_t maxNormalValueplusOne =
    ( 1u << static_cast<uint32_t>(
qpOcta ) );
    for (int c = 0; c < 2; c++) {
      // Wrap around at Encoder.
      if (residual2D[c] < −center){
        residual2D[c] = residual2D[c] + maxNormalValueplusOne;
      }
      else if (residual2D[c] > center−1){
        residual2D[c] = residual2D[c] − maxNormalValueplusOne;
      }
    }
  } else {
    residual2D = orig2D − pred2D;
  }
```

As for the normal coding, the techniques of this disclosure as mentioned above adopt a fixed-point integer implementation of normal attribute encoding in the V-DMC, which could lead to fewer precision errors along with improved performance and less implementation issues. Further, the techniques of this disclosure may enable flexibility in the implementation. Flexibilities in the architecture and/or implementation will now be discussed.
1. The current implementation and code as shown above uses min, max, qn, and qpOcta values to perform normalization, scaling, quantization, etc. These values need not be fixed but can be variable. These values can also be computed as a preprocessing and plugged in during the calculations.
2. As explained in the previous point, the min, max, qn, and qpOcta values are employed to perform normalization, scaling, quantization, etc. However, performing the normalization, scaling, and quantization in these steps does not need to be restricted. Other techniques for quantization, scaling, and normalization may be used.
3. The order of scaling, normalization, quantization in formulas is not necessarily fixed.
4. Most of operations are performed in unsigned integers. However, it is not restricted to just unsigned integers but can also employ signed integers.
5. In some implementations, clipping operations may be added in one or more intermediate steps to ensure that operating bits/value range do not overflow the bit depth of the registers/variables used.
6. In some implementations, one or more bitdepths of the normal vectors or the octahedral representations may not be signaled, and may be derived from one or more bitdepths signaled. E.g., bit depth of the octahedral representation may be selected based on a look-up table of the normal vector bitdepth.

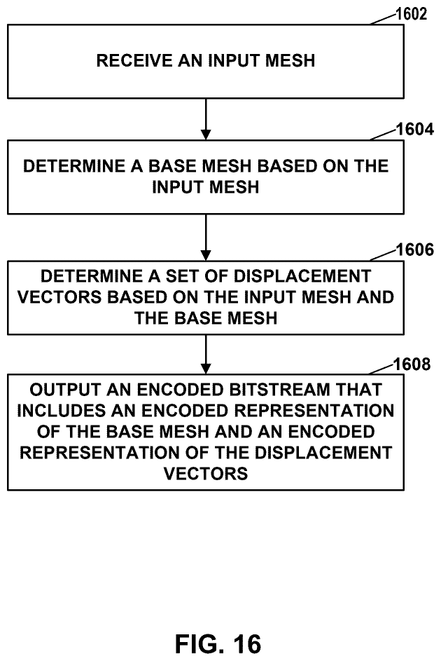

FIG. 16 is a flowchart illustrating an example process for encoding a mesh. Although described with respect to V-DMC encoder 200 (FIGS. 1 and 2), it should be understood that other devices may be configured to perform a process similar to that of FIG. 16.

In the example of FIG. 16, V-DMC encoder 200 receives an input mesh (1602). V-DMC encoder 200 determines a base mesh based on the input mesh (1604). V-DMC encoder 200 determines a set of displacement vectors based on the input mesh and the base mesh (1606). V-DMC encoder 200 outputs an encoded bitstream that includes an encoded representation of the base mesh and an encoded representation of the displacement vectors (1608). V-DMC encoder 200 may additionally determine attribute values from the input mesh and include an encoded representation of the attribute values vectors in the encoded bitstream.

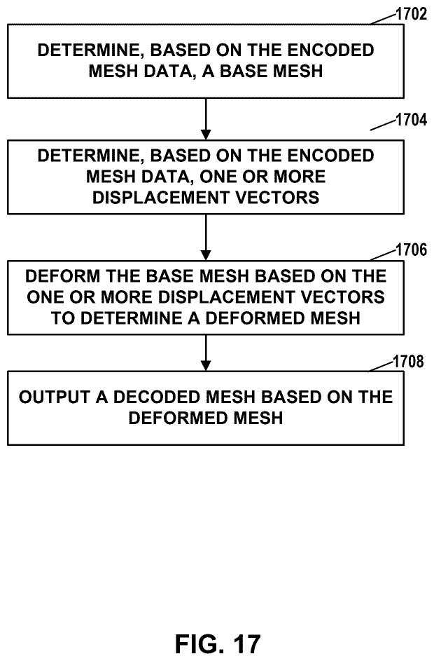

FIG. 17 is a flowchart illustrating an example process for decoding a compressed bitstream of mesh data. Although described with respect to V-DMC decoder 300 (FIGS. 1 and 3), it should be understood that other devices may be configured to perform a process similar to that of FIG. 17.

In the example of FIG. 17, V-DMC decoder 300 determines, based on the encoded mesh data, a base mesh (1702). V-DMC decoder 300 determines, based on the encoded mesh data, one or more displacement vectors (1704). V-DMC decoder 300 deforms the base mesh using the one or more displacement vectors to determine a deformed mesh (1706). For example, the base mesh may have a first set of vertices, and V-DMC decoder 300 may subdivide the base mesh to determine an additional set of vertices for the base mesh. To deform the base mesh, V-DMC decoder 300 may modify the locations of the additional set of vertices based on the one or more displacement vectors. V-DMC decoder 300 outputs a decoded mesh based on the deformed mesh (1708). V-DMC decoder 300 may, for example, output the decoded mesh for storage, transmission, or display.

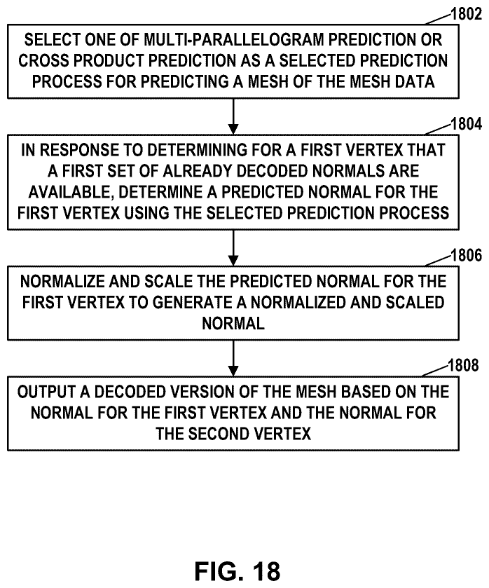

FIG. 18 is a flowchart illustrating an example process for decoding a compressed bitstream of mesh data. Although described with respect to V-DMC decoder 300 (FIGS. 1 and 3), it should be understood that other devices may be configured to perform a process similar to that of FIG. 18.

In the example of FIG. 18, V-DMC decoder 300 selects one of multi-parallelogram prediction or cross product prediction as a selected prediction process for predicting a mesh of the mesh data (1802). In response to determining for a first vertex that a first set of already decoded normals are available, V-DMC decoder 300 determines a predicted normal for the first vertex using the selected prediction process (1804). V-DMC decoder 300 normalizes and scale the predicted normal for the first vertex to generate a normalized and scaled normal (1806). V-DMC decoder 300 outputs a decoded version of the mesh based on the normal for the first vertex and the normal for the second vertex (1808)

Examples in the various aspects of this disclosure may be used individually or in any combination.

The following numbered clauses illustrate one or more aspects of the devices and techniques described in this disclosure.

Clause 1A: A method of processing mesh data, the method comprising: any technique or combination of techniques described in this disclosure.

Clause 2A: The method of any of clause 1A, further comprising generating the mesh data.

Clause 3A: A device for processing mesh data, the device comprising: a memory configured to store the mesh data; and one or more processors coupled to the memory, implemented in circuitry, and configured to perform any technique or combination of techniques described in this disclosure.

Clause 4A: The device clause 3A, wherein the device comprises a decoder.

Clause 5A: The device of clause 3A, wherein the device comprises an encoder.

Clause 6A: The device of any of clauses 3A-4A, further comprising a device to generate the mesh data.

Clause 7A: The device of any of clauses 3A-6A, further comprising a display to present imagery based on data.

Clause 8A: A computer-readable storage medium having stored thereon instructions that, when executed, cause one or more processors to perform any technique or combination of techniques described in this disclosure.

Clause 1B: A device for processing mesh data, the device comprising: a memory; and processing circuitry coupled to the memory and configured to: select one of multi-parallelogram prediction or cross product prediction as a selected prediction process for a mesh of the mesh data; in response to determining for a first vertex of the mesh that a first set of already decoded normal vectors are available, determine a predicted normal vector for the first vertex using the selected prediction process; normalize and scale the predicted normal vector for the first vertex to generate a normalized and scaled normal vector; and output a decoded version of the mesh based on the normalized and scaled normal vector.

Clause 2B: The device of clause 1B, wherein the processing circuitry is further configured to: convert the normalized and scaled normal vector into a fixed-point integer representation; and output the decoded version of the mesh based on the fixed-point integer representation of the normalized and scaled normal vector.

Clause 3B: The device of clauses 1B-2B, wherein the processing circuitry is further configured to: in response to determining for a second vertex of the mesh that a second set of already decoded normal vectors are unavailable, predict a normal vector for the second vertex using a delta prediction process.

Clause 4B: The device of clause 3B, wherein to predict the normal vector for the second vertex using the delta prediction process, the processing circuitry is configured to: identify a single vertex on a same triangle as the second vertex; set a predicted normal value for the second vertex to be equal to a vertex value of a normal vector for the single vertex; receive a difference value; and add the difference value to the predicted normal value for the second vertex to determine the normal vector for the second vertex.

Clause 5B: The device of any of clauses 1B-4B, wherein the selected prediction process comprises multi-parallelogram prediction and wherein to predict the normal vector for the first vertex using the selected prediction process, the processing circuitry is configured to: determine a predicted normal value for the first vertex based on a previous normal value plus a next normal value minus an opposite normal value.

Clause 6B: The device of any of clauses 1B-4B, wherein the selected prediction process comprises cross product prediction and wherein to predict the normal vector for the first vertex using the selected prediction process, the processing circuitry is configured to: determine a first vector between a previous vertex and the first vertex; determine a second vector between a next vertex and the first vertex; and determine a predicted normal vector for the first vertex based on a cross product of the first vector and the second vector.

Clause 7B: The device of any of clauses 1B-6B, wherein the processing circuitry is further configured to: perform three-dimensional (3D) to two-dimensional (2D) octahedral conversion on the normalized and scaled normal vector to determine a 2D octahedral representation of the normal vector.

Clause 8B: The device of clause 7B, wherein the processing circuitry is further configured to: add residual data to the 2D octahedral representation of the normal vector to determine a 2D reconstructed normal vector.

Clause 9B: The device of clause 8B, wherein the processing circuitry is further configured to: convert the 2D reconstructed normal vector to a 3D unit vector.

Clause 10B: The device of clause 9B, wherein the processing circuitry is further configured to: add second residual data to the 3D unit vector to determine a 3D reconstructed normal vector.

Clause 11B: The device of clause 10B, wherein to output the decoded version of the mesh based on the normalized and scaled normal vector, the processing circuitry is configured to output the decoded version of the mesh based on the 3D reconstructed normal vector.

Clause 12B: The device of any of clauses 1B-11B, further comprising a display to present imagery based on the decoded version of the mesh.

Clause 13B: A method for processing mesh data, the method comprising: selecting one of multi-parallelogram prediction or cross product prediction as a selected prediction process for a mesh of mesh data; in response to determining for a first vertex of the mesh that a first set of already decoded normal vectors are available, determining a predicted normal vector for the first vertex using the selected prediction process; normalizing and scaling the predicted normal vector for the first vertex to generate a normalized and scaled normal vector; and outputting a decoded version of the mesh based on the normalized and scaled normal vector.

Clause 14B: The method of clause 13B, further comprising: converting the normalized and scaled normal vector into a fixed-point integer representation; and outputting the decoded version of the mesh based on the fixed-point integer representation of the normalized and scaled normal vector.

Clause 15B: The method of any of clauses 13B-14B, further comprising: in response to determining for a second vertex of the mesh that a second set of already decoded normal vectors are unavailable, predicting a normal vector for the second vertex using a delta prediction process.

Clause 16B: The method of clause 15B, wherein predicting the normal vector for the second vertex using the delta prediction process comprises: identifying a single vertex on a same triangle as the second vertex; setting a predicted normal value for the second vertex to be equal to a vertex value of a normal vector for the single vertex; receiving a difference value; and adding the difference value to the predicted normal value for the second vertex to determine the normal vector for the second vertex.

Clause 17B: The method of any of clauses 13B-16B, further comprising: performing three-dimensional (3D) to two-dimensional (2D) octahedral conversion on the normalized and scaled normal vector to determine a 2D octahedral representation of the normal vector.

Clause 18B: The method of clause 17B, further comprising: adding residual data to the 2D octahedral representation of the normal vector to determine a 2D reconstructed normal vector.

Clause 19B: The method of clause 18B, further comprising: converting the 2D reconstructed normal vector to a 3D unit vector.

Clause 20B: The method of clause 19B, further comprising: adding second residual data to the 3D unit vector to determine a 3D reconstructed normal vector.

Clause 21B: The method of clause 20B, wherein outputting the decoded version of the mesh based on the normalized and scaled normal vector comprises outputting the decoded version of the mesh based on the 3D reconstructed normal vector.

Clause 22B: A computer-readable storage medium storing instructions that when executed by one or more processors cause the one or more processors to perform the method of any of clauses 13B-21B.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A device for processing mesh data, the device comprising:
a memory; and
processing circuitry coupled to the memory and configured to:
select one of multi-parallelogram prediction or cross product prediction as a selected prediction process for a mesh of the mesh data;
in response to determining for a first vertex of the mesh that a first set of already decoded normal vectors are available, determine a predicted normal vector for the first vertex using the selected prediction process;
normalize and scale the predicted normal vector for the first vertex to generate a normalized and scaled normal vector; and
output a decoded version of the mesh based on the normalized and scaled normal vector.

2. The device of claim 1, wherein the processing circuitry is further configured to:
convert the normalized and scaled normal vector into a fixed-point integer representation; and
output the decoded version of the mesh based on the fixed-point integer representation of the normalized and scaled normal vector.

3. The device of claim 1, wherein the processing circuitry is further configured to:
in response to determining for a second vertex of the mesh that a second set of already decoded normal vectors are unavailable, predict a normal vector for the second vertex using a delta prediction process.

4. The device of claim 3, wherein to predict the normal vector for the second vertex using the delta prediction process, the processing circuitry is configured to:
identify a single vertex on a same triangle as the second vertex;
set a predicted normal value for the second vertex to be equal to a vertex value of a normal vector for the single vertex;
receive a difference value; and
add the difference value to the predicted normal value for the second vertex to determine the normal vector for the second vertex.

5. The device of claim 1, wherein the selected prediction process comprises multi-parallelogram prediction and wherein to predict the normal vector for the first vertex using the selected prediction process, the processing circuitry is configured to:
determine a predicted normal value for the first vertex based on a previous normal value plus a next normal value minus an opposite normal value.

6. The device of claim 1, wherein the selected prediction process comprises cross product prediction and wherein to predict the normal vector for the first vertex using the selected prediction process, the processing circuitry is configured to:
determine a first vector between a previous vertex and the first vertex;
determine a second vector between a next vertex and the first vertex; and
determine a predicted normal vector for the first vertex based on a cross product of the first vector and the second vector.

7. The device of claim 1, wherein the processing circuitry is further configured to:
perform three-dimensional (3D) to two-dimensional (2D) octahedral conversion on the normalized and scaled normal vector to determine a 2D octahedral representation of the normal vector.

8. The device of claim 7, wherein the processing circuitry is further configured to:
add residual data to the 2D octahedral representation of the normal vector to determine a 2D reconstructed normal vector.

9. The device of claim 8, wherein the processing circuitry is further configured to:
convert the 2D reconstructed normal vector to a 3D unit vector.

10. The device of claim 9, wherein the processing circuitry is further configured to:
add second residual data to the 3D unit vector to determine a 3D reconstructed normal vector.

11. The device of claim 10, wherein to output the decoded version of the mesh based on the normalized and scaled normal vector, the processing circuitry is configured to output the decoded version of the mesh based on the 3D reconstructed normal vector.

12. The device of claim 1, further comprising a display to present imagery based on the decoded version of the mesh.

13. A method for processing mesh data, the method comprising:
selecting one of multi-parallelogram prediction or cross product prediction as a selected prediction process for a mesh of mesh data;
in response to determining for a first vertex of the mesh that a first set of already decoded normal vectors are available, determining a predicted normal vector for the first vertex using the selected prediction process;
normalizing and scaling the predicted normal vector for the first vertex to generate a normalized and scaled normal vector; and
outputting a decoded version of the mesh based on the normalized and scaled normal vector.

14. The method of claim 13, further comprising:
converting the normalized and scaled normal vector into a fixed-point integer representation; and
outputting the decoded version of the mesh based on the fixed-point integer representation of the normalized and scaled normal vector.

15. The method of claim 13, further comprising:
in response to determining for a second vertex of the mesh that a second set of already decoded normal vectors are unavailable, predicting a normal vector for the second vertex using a delta prediction process.

16. The method of claim 15, wherein predicting the normal vector for the second vertex using the delta prediction process comprises:
identifying a single vertex on a same triangle as the second vertex;
setting a predicted normal value for the second vertex to be equal to a vertex value of a normal vector for the single vertex;
receiving a difference value; and
adding the difference value to the predicted normal value for the second vertex to determine the normal vector for the second vertex.

17. The method of claim 13, wherein the selected prediction process comprises multi-parallelogram prediction and wherein predicting the normal vector for the first vertex using the selected prediction process comprises:
determining a predicted normal value for the first vertex based on a previous normal value plus a next normal value minus an opposite normal value.

18. The method of claim 13, wherein the selected prediction process comprises cross product prediction and wherein predicting the normal vector for the first vertex using the selected prediction process comprises:
determining a first vector between a previous vertex and the first vertex;
determining a second vector between a next vertex and the first vertex; and
determining a predicted normal vector for the first vertex based on a cross product of the first vector and the second vector.

19. The method of claim 13, further comprising:
performing three-dimensional (3D) to two-dimensional (2D) octahedral conversion on the normalized and scaled normal vector to determine a 2D octahedral representation of the normal vector.

20. The method of claim 19, further comprising:
adding residual data to the 2D octahedral representation of the normal vector to determine a 2D reconstructed normal vector.

21. The method of claim 20, further comprising:
converting the 2D reconstructed normal vector to a 3D unit vector.

22. The method of claim 21, further comprising:
adding second residual data to the 3D unit vector to determine a 3D reconstructed normal vector.

23. The method of claim 22, wherein outputting the decoded version of the mesh based on the normalized and scaled normal vector comprises outputting the decoded version of the mesh based on the 3D reconstructed normal vector.

24. A computer-readable storage medium storing instructions that when executed by one or more processors cause the one or more processors to:
select one of multi-parallelogram prediction or cross product prediction as a selected prediction process for a mesh of mesh data;
in response to determining for a first vertex of the mesh that a first set of already decoded normal vectors are available, determine a predicted normal vector for the first vertex using the selected prediction process;
normalize and scale the predicted normal vector for the first vertex to generate a normalized and scaled normal vector; and
output a decoded version of the mesh based on the normalized and scaled normal vector.

25. The computer-readable storage medium of claim 24, wherein the instructions cause the one or more processors to:
convert the normalized and scaled normal vector into a fixed-point integer representation; and
output the decoded version of the mesh based on the fixed-point integer representation of the normalized and scaled normal vector.

26. The computer-readable storage medium of claim 24, wherein the instructions cause the one or more processors to:
in response to determining for a second vertex of the mesh that a second set of already decoded normal vectors are unavailable, predict a normal vector for the second vertex using a delta prediction process.

27. The computer-readable storage medium of claim 26, wherein to predict the normal vector for the second vertex using the delta prediction process, the instructions cause the one or more processors to:
identify a single vertex on a same triangle as the second vertex;
set a predicted normal value for the second vertex to be equal to a vertex value of a normal vector for the single vertex;
receive a difference value; and
add the difference value to the predicted normal value for the second vertex to determine the normal vector for the second vertex.

28. The computer-readable storage medium of claim 24, wherein the selected prediction process comprises multi-parallelogram prediction and wherein to predict the normal vector for the first vertex using the selected prediction process, the instructions cause the one or more processors to:
determine a predicted normal value for the first vertex based on a previous normal value plus a next normal value minus an opposite normal value.

29. The computer-readable storage medium of claim 24, wherein the selected prediction process comprises cross product prediction and wherein to predict the normal vector for the first vertex using the selected prediction process, wherein the instructions cause the one or more processors to:
determine a first vector between a previous vertex and the first vertex;
determine a second vector between a next vertex and the first vertex; and
determine a predicted normal vector for the first vertex based on a cross product of the first vector and the second vector.

30. The computer-readable storage medium of claim 24, wherein the instructions cause the one or more processors to:
perform three-dimensional (3D) to two-dimensional (2D) octahedral conversion on the normalized and scaled normal vector to determine a 2D octahedral representation of the normal vector.

31. The computer-readable storage medium of claim 30, wherein the instructions cause the one or more processors to:
add residual data to the 2D octahedral representation of the normal vector to determine a 2D reconstructed normal vector.

32. The computer-readable storage medium of claim 31, wherein the instructions cause the one or more processors to:
convert the 2D reconstructed normal vector to a 3D unit vector.

33. The computer-readable storage medium of claim 32, wherein the instructions cause the one or more processors to:
add second residual data to the 3D unit vector to determine a 3D reconstructed normal vector.

34. The computer-readable storage medium of claim 33, wherein to output the decoded version of the mesh based on the normalized and scaled normal vector, the instructions cause the one or more processors to output the decoded version of the mesh based on the 3D reconstructed normal vector.
